(19) United States
(12) Patent Application Publication
(10) Pub. No.: US 2007/0177160 A1
(43) Pub. Date: Aug. 2, 2007

(54) THREE-DIMENSIONAL OBJECT INFORMATION ACQUISITION USING PATTERNED LIGHT PROJECTION WITH OPTIMIZED IMAGE-THRESHOLDING

(75) Inventor: Hiroyuki Sasaki, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/690,923

(22) Filed: Mar. 26, 2007

Related U.S. Application Data
(63) Continuation-in-part of application No. PCT/JP05/17678, filed on Sep. 27, 2005.

(30) Foreign Application Priority Data
Sep. 30, 2004 (JP) 2004-285736

(51) Int. Cl. G01B 11/24

(52) U.S. Cl. 356/603

(57) ABSTRACT

Techniques are disclosed of obtaining three-dimensional information pertaining to an object of interest, based on a light-pattern image acquired by digitally photographing the object with patterned light being projected onto the object, By an exemplary technique, a local adaptive spatial-filter is configured for the light-pattern image, based on a spatial frequency characteristic of the light-pattern image having a plurality of sub-areas, on a sub-area-by-sub-area basis, and local thresholds are set for the light-pattern image, based on image information acquired by locally applying the spatial filter to the light-pattern image, on a sub-area-by-sub-area basis.

### CROSS-REFERENCE TO RELATED APPLICATIONS

This application is based on Japanese Patent Application No. 2004-285736 filed Sep. 30, 2004, and International Application No. PCT/JP2005/017678 filed Sep. 27, 2005, the contents of which are incorporated hereinto by reference in its entirety.

This application is a continuation-in-part application of International Application No. PCT/JP2005/017678 filed Sep. 27, 2005, now pending, which was published in Japanese under PCT Article 21(2).

### BACKGROUND OF THE INVENTION

1 Field of the Invention

The invention relates to techniques of obtaining three-dimensional information pertaining to an object of interest, based on a light-pattern image acquired by digitally photographing the object with a light pattern or patterned light being projected onto the object, and more particularly to the setting of thresholds applicable to the light-pattern image for obtaining the three-dimensional information pertaining to the object.

2 Description of the Related Art

There are known techniques for use in, for example, measurement of the three-dimensional shape of an object of interest, in which three-dimensional information pertaining to the object is obtained based on a light-pattern image acquired by digitally photographing the object with a light pattern or patterned light (i.e., projection light pattern) being projected onto the object.

An exemplary version of such techniques is a space-encoding technique. By this space-encoding technique, N light-stripe patterns (i.e., striped projection-patterns) are projected onto an object of interest in succession, and the object is digitally photographed repetitively on a pattern-by-pattern basis. Thus, a three-dimensional space in which the object is placed is angularly partitioned into 2^{N} thin fan- or wedge-shaped subspaces, with the creation of N light-pattern images each of which is a striped luminance image or gray image.

This space-encoding technique, when implemented, would further threshold the resulting N light-pattern images respectively, to thereby convert these light-pattern images into N binarized images. Each binarized image is partitioned into a plurality of pixels each having its luminance value (either a binary “or Go”).

This space-encoding technique, when implemented, would still further make pixel-by-pixel allocation of N bits to the luminance values of the N binarized images, on an image-by-mage basis. Those N bits collectively make up a space code, which start with a least significant bit (LSB), and end up with a most significant bit (MSB).

By this space-encoding technique, a space-coded image is eventually obtained which has its space codes in association with the respective pixels of the space-coded image. Further, 3-D (three-dimensional) information pertaining to the object is obtained based on the obtained space-coded image through triangulation. The 3D information is obtained to include various sets of information staring with 3-D locations of a plurality of pixels collectively making up the object.

In this space-encoding technique, the thresholding operation is typically effected so as to make a pixel-by-pixel comparison between each of the light-pattern images and a common threshold image, with respect to luminance value. Japanese Patent No. 2921748 discloses an exemplary conventional technique of acquiring such a threshold image.

More specifically, by the above-mentioned exemplary conventional technique, eight basic patterns of slits are contemplated, and there are employed for these eight basic patterns of slits, a first set of eight patterns of slits and a second set of eight patterns of slits.

The eight patterns of the first set are for use in digitally photographing respective positive images, while the eight patterns of the second set are for use in digitally photographing respective negative images. The eight patterns of the second set are reversed with respect to the respective eight patterns of the first set.

Upon practice of this exemplary conventional technique, the eight positive images are obtained by digitally photographing an object of interest, by sequentially using the first set of eight patterns of slits for positive images. Additionally, the eight negative images are obtained by digitally photographing the same object, by sequentially using the second set of eight patterns of slits for negative images.

Upon practice of this technique, further, threshold images are composed by combining, on a basic-pattern-by-basic-pattern basis, two difference images, one obtained by subtracting the respective negative images from the respective positive images, the other obtained by subtracting the respective positive images from the respective negative images.

For this reason, this technique, for its implementation, requires a combined operation of the projection onto an object of interest and the image-capture of the object, to be performed a number of repetitions equal to twice the total number of the basic patterns of slits, that is to say, twice the number of repetitions that a conventional space-encoding technique requires the projection and image-capture to be performed.

By an alternative exemplary conventional technique, a mask is employed which is in the shape of an elongated-rectangle having a fixed width or size such that it accommodates two of a plurality of patterned lines which together make up a light-pattern image. Each patterned line acts as an exemplary bright portion of the light-pattern image.

The mask is applied to successive segments of the light-pattern image, respectively, and a segment-by-segment calculation of local thresholds is made such that each local threshold is determined to be equal to the average of luminance values of a plurality of pixels located within the mask.

In other words, this technique is an exemplary conventional technique of setting local thresholds so as to be adaptive to possible spatial changes in brightness of an object of interest.

This threshold setting technique, however, suffers from difficulties in setting thresholds to accurately follow a spatial change in the true brightness of light reflected from an object of interest, as will become apparent later on.

### BRIEF SUMMARY OF THE INVENTION

According to an illustrative embodiment of the present invention, three-dimensional information pertaining to an object of interest is obtained based on a light-pattern image (i.e., one or more light-pattern images) acquired by digitally photographing the object with a light pattern (i.e., one or more light patterns, or one or more patterns of structured light) being projected onto the object.

According to the illustrative embodiment, a local adaptive spatial-filter is configured for the light-pattern image, based on a spatial frequency characteristic of the light-pattern image having a plurality of sub-areas, on a sub-area-by-sub-area basis.

According to the illustrative embodiment, local thresholds are set for the light-pattern image, based on image information acquired by locally applying the spatial filter to the light-pattern image, on a sub-area-by-sub-area basis. The local thresholds are applicable to the respective sub-areas of the light-pattern image for obtaining the three-dimensional information pertaining to the object.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a perspective view showing the exterior of an image input/output device 1 for suitable use in implementing a three-dimensional (3-D) information acquisition method:in accordance with an embodiment of the present invention:

FIG. 2 is a plan view showing the interior configuration of an image-capturing head 2 in FIG. 1;

FIG. 3(a) is an enlarged plan view showing a projecting section 13 depicted in FIG. 2, FIG. 3(b) is an enlarged front view showing a light-source lens 18 depicted:in FIG. 2, and FIG. 3(a) is an enlarged front view showing a projection LCD 19 and a CCD 22 depicted in FIG. 2;

FIG, 4(a) is a combination of a side view for explanation of the layout of a plurality of LEDs 17 depicted in FIG. 3, and a graph showing the illuminance distribution provided solely by one of the LEDs 17, and FIG. 4(b) is a combination of a front view showing the plurality of LEDs 17, and a graph showing the composite illuminance distribution provided compositely by the plurality of LEDs 17;

FIG. 5 is a block diagram conceptually showing the electric configuration of the image input/output device 1 depicted in FIG. 1;

FIG. 6 is a flow chart conceptually showing a main operation executed in a camera control program depicted in FIG. 5:

FIG. 7 is a flow chart conceptually showing digital camera processing executed at step S605 depicted in FIG. 6:

FIG. 8 is a flow chart conceptually showing webcam processing executed at step S607 depicted in FIG. 6;

FIG. 9 is a flow chart conceptually showing a projecting operation executed at step S806 depicted in FIG. 8;

FIG. 10 is a flow chart conceptually showing stereoscopic image processing executed at step S609 depicted in FIG. 6;

FIG. 11(a) is a combination of a plan view and a side view for explanation of the principle of a space-encoding technique employed in the stereoscopic image processing of FIG. 10, and FIG. 11(b) is a plan view showing three mask patterns;

FIG. 12(a) is a flow chart conceptually showing 3-D shape detection processing executed at step S1006 depicted in FIG. 10, in the name of a 3-D shape detection processing routine, FIG. 12(b) is a flow chart conceptually showing the details of step S1210 in the 3-D shape detection processing routine, in the name of an image-capture processing subroutine, and FIG. 12(c) is a flow chart conceptually showing the details of step S1220 in the 3-D shape detection processing routine, in the name of a 3-D measurement processing subroutine;

FIG. 13 is a flow chart conceptually showing a coded-image generation program 36d executed at step S1222 depicted in FIG. 12;

FIG. 14 is a front view showing an example of a representative light-pattern image used at step S101 depicted in FIG. 13;

FIG. 15 is a graph for explanation of how a luminance value of the representative light-pattern image depicted in FIG. 14 changes spatially in an array direction of patterned lines;

FIG. 16(a) is a plan view for explanation of the relations between a portion A depicted in FIG. 14 and a fixed-size window, and FIG. 16(b) is a plan view for explanation of the relations between a portion B depicted in FIG. 14 and the fixed-size window:

FIG. 17 is a graph for explanation of how a threshold changes spatially in the array direction of the patterned lines, the threshold being obtained for the portion A depicted in FIG. 14 using the fixed-size window;

FIG. 18 is a graph for explanation of how a threshold changes spatially in the array direction of the patterned lines, the threshold being obtained for the portion B depicted in FIG. 14 using the fixed-size window;

FIG. 19 is a plan view showing a variable-size windows VW which is locally configured for the representative light-pattern image depicted in FIG. 14 in order to locally set thresholds TH for use in a binarizing operation;

FIG. 20 is a front view for explanation of the fixed-size window which is provided for the representative light-pattern image depicted in FIG. 14 in order to measure a period in which the patterned lines are arrayed in the representative light-pattern image;

FIG. 21 is a graph showing an example of the frequency characteristic of luminance values which are obtained for the representative light-pattern image depicted in FIG. 14 by the use of the fixed-size window depicted in FIG. 20; and FIG. 22(a) is a side view for explanation of both coordinate transformation between a two-dimensional (2-D) CCD coordinate system and a 3-D real-space coordinate system, and coordinate transformation between a 2-D LCD coordinate system and the 3-D real-space coordinate system, both performed by the implementation of step S1225 depicted in FIG. 12, and FIG. 22(b) is a plan view for explanation of both the former and the latter coordinate transformation.

### DETAILED DESCRIPTION OF THE INVENTION

According to the invention, there are provided the following modes as the illustrative embodiments of the invention.

These modes will be stated below so as to be sectioned and numbered, and so as to depend upon the other mode or modes, where appropriate. This is for a better understanding of some of a plurality of technical features and a plurality of combinations thereof disclosed in this description, and does not mean that the scope of these features and combinations is interpreted to be limited to the scope of the following modes of this Invention.

That is to say, it should be interpreted that it is allowable to select the technical features which are stated in this description but which are not stated in the following modes, as the technical features of this invention.

Furthermore, stating each one of the modes of the invention in such a dependent form as to depend from the other mode or modes does not exclude the possibility that the technical features set forth in a dependent-form mode become independent of those set forth In the corresponding depended mode or modes and to be removed therefrom. It should be interpreted that the technical features set forth in a dependent-form mode are allowed to become independent, where appropriate. (1) A method of obtaining three-dimensional information pertaining to an object of Interest, based on a light-pattern image acquired by digitally photographing the object with spatially patterned light being projected onto the object, the method comprising;

a spatial-filter configuration step of configuring a local adaptive spatial-filter for the light-pattern image, based on a spatial frequency characteristic of the light-pattern image having a plurality of sub-areas, on a sub-area-by-sub-area basis; and

a threshold setting step of setting local thresholds for the light-pattern image, based on image information acquired by locally applying the spatial filter to the light-pattern image, on a sub-area-by-sub-area basis, wherein the local thresholds are applicable to the respective sub-areas of the light-pattern image for obtaining the three-dimensional information pertaining to the object.

The above-mentioned alternative exemplary conventional technique of setting thresholds requires an exact coincidence of the width of the mask with one of the integer multiples of the distance between adjacent ones of a plurality of patterned lines in an actual light-pattern image.

A failure to fulfill the requirement would cause unbalance in area between bright portion(s) and dark portion(s) within the same mask, resulting in the deviation of the average of luminance values of a plurality of pixels within the same mask, from the average of a true luminance-value of an actual bright portion and a true luminance-value of an actual dark portion.

This threshold setting technique, nevertheless, encounters practical difficulties in fulfilling the above requirement without exception, for the reasons which will be described below in more detail.

Upon projection of a light pattern of equally-spaced patterned-lines onto an object, a light-pattern image is obtained by digitally photographing the object, so as to exhibit an array of a plurality of patterned lines, similarly with the patterned lines in the light pattern to be projected (hereinafter, referred to as “projection light-pattern”).

Irrespective of the projection light-pattern being formed as patterned lines equally spaced, the light-pattern image is formed as patterned lines arrayed at intervals each varying depending on the geometrical arrangement/orientation of the object relative to both a projector for use in projecting the light pattern onto the object, and a camera for use in digitally photographing the object.

The geometrical arrangement/orientation may be, for example, the direction in which the light pattern is projected onto the object, the direction in which the object is digitally photographed, the orientation of the surface of the object, the distance between the projector and the object, the distance between the camera and the object, etc.

In addition, a light pattern emitted from a projector is made up of a plurality of patterned lines equally spaced, while a light-pattern image obtained by digitally photographing an object with such light pattern being projected onto the object is made up of a plurality of patterned lines at intervals that may be spatially different from one another.

Describing the reasons more specifically, when an object has its local surface formed as a single flat plane, and a light pattern is projected onto the local surface, a light-pattern image, which is formed by light reflected from the object as a result of the projection of the light pattern, is made up of a plurality of patterned lines at intervals that are not spatially different from one another, as well as the projection light-pattern.

When, however, an object has its local surface formed as a single curved plane, a complex of two or more different curved planes or a complex of two or more different flat planes, such as a shape having geometric irregularities, and a light pattern is projected onto the local surface, a light-pattern image, which is formed by light reflected from the object as a result of the projection of the light pattern, is made up of a plurality of patterned lines at intervals that are spatially different from one another.

Summarizing the above, a possibility exists that a light-pattern image is made up of a plurality of patterned lines at distances spatially variable. The aforementioned threshold setting technique, irrespective of the existing possibility, defines the mask so as to have its fixed width, for setting local thresholds.

Due to the above, this threshold setting technique, when implemented so as to move the fixed-width mask sequentially on a light-pattern image which has patterned lines at spatially different distances, would cause the number of patterned lines within the mask to alternately increase and decrease, resulting in the occurrence of spatial vibrations in the luminance-value average of coexisting pixels within the mask. A threshold, when set based on spatially-oscillating luminance-values, would spatially oscillate accordingly.

In general, upon projection of spatially uniform light onto an object of interest, the brightness of each portion of the object is expressed as the luminance value of light reflected from each portion of the object.

As a result, each portion of an object, even if light is projected onto each portion with the same intensity as that of other portions of the same object, is different in brightness from other portions of the same object, provided that each portion is different from other portions in terms of surface orientation, surface light -reflectivity, the distance from the projector, the distance from the camera, etc.

With such nature in mind, there will be discussed below the nature of a light-pattern image formed as a result of the projection of patterned light onto an object.

A plurality of patterned lines forming a light-pattern image are not always in common in luminance value to one another, wherein every one of all the patterned lines constitutes a bright portion or field of the light-pattern image. In other words, a possibility exists that the same light-pattern image has both a brighter patterned-line (i.e., a brighter bright-portion) and a darker patterned-line (i.e., a darker bright-portion).

Those patterned lines, however, irrespective of the presence of such a difference in the absolute luminance value between the patterned lines, are required to be binarized such that every one of the patterned lines is classified as a bright portion of the light-pattern image, for enhancing the accuracy of the binarizing operation.

As a result, a threshold for use in binarizing those patterned lines is preferably tracked or changed to follow a spatial change in the true brightness of light reflected from an object of interest.

Practically, however, it is unusual for the surface of an object of interest to exhibit spatial oscillation In property (e.g., geometry, color), in synchronization with spatial oscillation in property (e.g., luminance) of the light pattern to be projected onto the surface of the object.

For this reason, it is naturally discussed that the setting of a spatially-oscillating local-threshold for a light-pattern image by the aforementioned threshold setting technique would cause degradation in the accuracy of the binarizing operation.

As will be evident from the foregoing description, the above-mentioned threshold setting technique suffers from difficulties in setting thresholds to accurately follow a spatial change in the true brightness of light reflected from an object of interest.

In contrast, the method according to the present mode (1) which is an illustrative embodiment of the invention, for the setting of local thresholds applicable to respective sub-areas of a light-pattern image, on a sub-area-by-sub-area basis, a local adaptive spatial-filter for the light-pattern image is configured based on a spatial frequency characteristic of the light-pattern image, on a sub-area-by-sub-area basis.

The sub-area-by-sub-area application of the thus-configured spatial filter to the light-pattern image allows the thresholds to be defined sub-areas by sub-area.

In other words, in this method, the employment of a variable spatial filter having a filtering characteristic variable with changes in position of a target local region on a light-pattern image allows local thresholds to be defined for the light-pattern image.

This method, therefore, would allow a local spatial-filter, which is configurable locally for a respective sub-area of a light-pattern image, to be configured so as to adapt to the spatial frequency characteristic of a corresponding one of the sub-areas of the light-pattern image.

As a result, local thresholds, which are set individually for respective sub-areas of a light-pattern image, to be set such that each threshold adapts to the spatial frequency characteristic of a corresponding one of the sub-areas of the light-pattern image.

This method, therefore, would make it easier to suppress a tendency of thresholds to oscillate spatially for a Light-pattern image, as opposed to when thresholds are set for respective sub-areas of a light-pattern image as a result of the application of a spatial filter having a fixed filtering characteristic (e.g., a fixed window having a fixed width) to the respective sub-areas of the light-pattern image.

The term “three-dimensional information” set forth in the present mode, although, typically, includes information indicative of three-dimensional locations of a plurality of individual pixels forming an object of interest, is not limiting, and may include, for example, information on color or texture of individual pixels of the object, geometrical information for defining polygons approximating at least the surface of the object (e.g., information on a plurality of vertices of those polygons and information on a plurality of planes interconnecting these vertices), etc.

The “spatial-filter configuration step” set forth in the present mode may be a step of configuring a local adaptive spatial-filter, using image information of a plurality of adjacent pixels (decimated or non-decimated), on a per-pixel basis or on a per-group-of-adjacent-pixels basis.

The “threshold setting step” set forth in the present mode may be a step of setting a local threshold, using image information of a plurality of adjacent pixels (decimated or non-decimated), on a per-pixel basis or on a per-group-of-adjacent-pixels basis.

The “patterned light” may be in the form of a two-dimensional projected-light-pattern resulting from spatial modulation of a light beam using an array of shutter elements such as mechanically actuated slits, liquid crystal gates, or electro-optical crystal gates, or may be formed using mechanical, electrical or optical scanning of a narrow stripe on the object.

The term “objects” may be interpreted to mean any kind of scene, including, for example, an isolated physical body, a group of such bodies, etc.

The term “light” is not intended to be limiting to visible wavelength bands, and light refers to any suitable wavelength of electromagnetic radiation. (2) The method according to mode (1), wherein the spatial-filter configuration step includes;

acquiring the spatial frequency characteristic based on image information of each sub-area of the light-pattern image which is extracted from the light-pattern image by local application of a window function thereto, on a sub-area-by-sub-area basis; and

configuring the spatial filter based on the acquired spatial frequency characteristic, on a sub-area-by-sub-area basis.

This method would allow the spatial frequency characteristic required for configuring the spatial filter locally for the respective sub-areas of the light-pattern image, to be obtained individually for the respective sub-areas of the light-pattern image, not to be obtained globally for the entire light-pattern image.

This method, therefore, would make it easier to obtain the spatial frequency characteristic of each of the sub-areas of the light-pattern image with enhanced accuracy. (3) The method according to mode (1) or (2), wherein the spatial filter is expressed by a matrix consisting of variable filter coefficients. (4) The method according to any one of modes (1)-(3), wherein the spatial filter has a characteristic realized by at least one of a rectangular window having a variable width, and a low-pass filter having a variable cut-off frequency. (5) The method according to any one of modes (1)-(4), wherein the patterned light is configured to have alternating bright portions and dark portions, the light-pattern image is configured to have alternating bright portions and dark portions so as to be consistent with a pattern of alternating bright and dark portions of the patterned light, and the spatial frequency characteristic indicates an alternation spatial-frequency at which the bright portions and the dark portions alternate within each sub-area of the light-pattern image. (6) The method according to mode (5), wherein the spatial-filter configuration step includes, when the spatial frequency characteristic data indicates a frequency-intensity profile having local maxima of intensity at different spatial-frequencies within each sub-area of the light-pattern image, configuring the spatial filter based on at least one of the different spatial-frequencies, on a sub-area-by-sub-area basis.

When a light-pattern image has a frequency-intensity profile having local maxima of intensity at different spatial-frequencies, the configuring of a spatial filter in view of a predominant one of those different spatial-frequencies, would enhance a tendency of the resulting local-thresholds for the light-pattern image to adequately adapt to the spatial frequency characteristics of the light-pattern image.

In light of the above findings, the method according to the present mode is implemented such that, when a light-pattern image has a frequency-intensity profile having local maxima of intensity at different spatial-frequencies, the spatial filter Is configured for each sub-area of the light-pattern image, based on at least one of the different spatial-frequencies, on a sub-area-by-sub-area basis. (7) The method according to mode (6), wherein the spatial-filter configuration step includes specifying the spatial frequency characteristic by application of Fourier transform to luminance distribution of the light-pattern image.

This method, owing to the employment of the Fourier transform, would make it easier to obtain the spatial frequency characteristic of a light-pattern image with enhanced accuracy. (8) The method according to mode (6) or (7), wherein the spatial filter is in the form of a rectangular window having a variable width, and

the spatial-filter configuration step includes a window-width determination step of determining the width of the rectangular window based on a selected one of the different spatial-frequencies which corresponds to the highest intensity among the local maxima of intensity within each frequency-intensity profile.

(9) The method according to mode (6) or (7), wherein the spatial filter is in the form of a low-pass filter having a variable cut-off frequency, and

the spatial-filter configuration step includes a out-off-frequency determination step of determining the cut-off frequency to be equal to a spatial frequency lower than a selected one of the different spatial-frequencies which corresponds to the highest intensity among the local maxima of intensity within each frequency-intensity profile, based on the selected spatial frequency.

(10) The method according to any one of modes (1)-(9), wherein the light-pattern image is formed by a plurality of pixels, and

the spatial-filter configuration step includes a spatial-frequency-characteristic calculation step of calculating the spatial frequency characteristic in association with a successively selected one of the plurality of pixels, based on luminance information indicative of a sub-plurality of the plurality of pixels which include the successively selected pixel and its at least one neighboring pixel.

This method would facilitate a pixel-by-pixel accurate calculation of local spatial-frequency-characteristic of pixels of a light-pattern image. (11) The method according to any one of modes (1)-(9), wherein the light-pattern image is formed by a plurality of pixels,

the plurality of pixels include a sub-plurality of non-adjacent pixels which are elected from the plurality of pixels so as not to be adjacent to each other, and

the spatial-filter configuration step includes a spatial-frequency-characteristic calculation step of calculating the spatial frequency characteristic in association with a successively selected one of the sub-plurality of elected non-adjacent pixels, based on luminance information indicative of a sub-plurality of the plurality of pixels which include the successively selected isolated-pixel and its at least one neighboring pixel.

This method would allow a plurality of pixels forming a light-pattern image to be typified by a sub-plurality of pixels which are isolated from each other and therefore are not located adjacent to each other. For a successively selected one of the sub-plurality of non-adjacent pixels, a local spatial-frequency-characteristic is calculated in a manner similar with the method according to the above mode (10).

In addition, for a successively selected one of the remaining pixels, its local spatial-frequency-characteristic may be calculated based on a separate local spatial-frequency-characteristic previously-calculated for at least one of the sub-plurality of non-adjacent pixels which is located in the vicinity of the successively selected remaining-pixel.

In an exemplary configuration, for a successively selected one of the remaining pixels, its local spatial-frequency-characteristic may be calculated by estimation from a separate local spatial-frequency-characteristic previously-calculated for ones of the sub-plurality of non-adjacent pixels between which the successively selected remaining-pixel is interposed and which are near each other.

As will be readily understood from the foregoing, this method would allow a reduction in computational effort required for calculation of local spatial-frequency-characteristics, with greater ease than when local spatial-frequency-characteristics are calculated for all of a plurality of pixels forming a light-pattern image, respectively, without utilization of separate local spatial-frequency-characteristics previously calculated. (12) The method according to mode (11), wherein the plurality of pixels further Include a sub-plurality of non-elected pixels, in addition to the sub-plurality of elected non-adjacent pixels, and the spatial-filter configuration step further includes a spatial-frequency-characteristic estimation step of estimating the spatial frequency characteristic in association with a successively selected one of the sub-plurality of non-elected pixels, using the spatial frequency characteristic which is calculated as a result of implementation of the spatial-frequency-characteristic calculation step for at least one of the sub-plurality of elected non-adjacent pixels which is located around the successively selected non-elected pixel.

This method would allow the spatial frequency characteristics to be calculated for a sub-plurality of non-elected pixels, which are ones of a plurality of pixels forming a light-pattern image but are other than the sub-plurality of elected non-adjacent pixels, by the use of separate spatial-frequency-characteristic previously calculated for the sub-plurality of elected non-adjacent pixels as a result of the implementation of the spatial-frequency-characteristic calculation step set forth In the above mode (11). (13) The method according to any one of modes (1)-(12), wherein the patterned light is configured to have alternating bright portions and dark portions,

the light-pattern image is configured to have alternating bright portions and dark portions so as to be consistent with a pattern of alternating bright and dark portions of the patterned light,

the patterned light includes a plurality of light patterns different from each other in terms of an alternation spatial-frequency at which the bright portions and the dark portions alternate,

the light-pattern image includes light-pattern images different from each other which correspond to the plurality of different light-patterns, respectively,

the spatial-filter configuration step includes configuring the spatial filter using a selected one of the plurality of different light-pattern images, on a sub-area-by-sub-area basis, and

the threshold setting step includes allocating the local thresholds to the plurality of different light-pattern images in common, on a sub-area-by-sub-area basis.

This method would not require the threshold setting operation to be performed light-pattern-image by light-pattern-image.

This method may be implemented in an arrangement in which a plurality of different light-pattern images are prepared for the original purpose of obtaining a 3-D information pertaining to an object of interest, and a selected one of the plurality of different light-pattern images which is used for configuring the spatial filter, is not used exclusively for the threshold setting operation.

This arrangement would make it unnecessary to project patterned light onto an object and digitally photograph the object only for the threshold setting operation.

(14) The method according to mode (13), wherein the selected one of different light-pattern images corresponds to a selected one of the plurality of different light-patterns in which the bright portions and the dark portions alternate in a substantially shortest alternation period among those of the plurality of different light-patterns.

This method would improve, for example, the width of a variable window which is an exemplary spatial filter so as to become smaller than when the selected one of different light-pattern images corresponds to a selected one of the plurality of different light-patterns in which the bright portions and the dark portions alternate in a period longer than the shortest alternation period.

The variable window is configured, for example, to have its width equal in length to exactly one of the integer multiples of the line spacing (i.e., pitch) of patterned lines found in a light-pattern image. In addition, the width of the variable window becomes smaller, as the line spacing of patterned lines, that is to say, the alternation period becomes shorter.

On the other hand, as the width of the variable window becomes smaller, an amount of data of a sub-image which is partially extracted from a light-pattern image using the variable window becomes smaller.

This method, therefore, would make it easier to reduce computational effort for the threshold setting operation.

(15) The method according to any one of modes (1)-(14), further comprising a binarization step of binarizing the light-pattern image using the local thresholds on a sub-area-by-sub-area basis, to thereby convert the light-pattern image into a binarized image.

This method would allow accurate local thresholds to be defined owing to the employment of a variable spatial filter, resulting in the accurate binarizing operation of a light-pattern image.

(16) The method according to mode (15), wherein the threshold setting step includes a threshold-image generation step of generating a threshold image by pixel-by-pixel arranging the thresholds in positional association with a plurality of pixels forming the light-pattern image, respectively, and

the binarization step includes a binarized-image generation step of generating the binarized image by making a pixel-by-pixel comparison between the generated threshold image and the light-pattern image with each other with respect to luminance value.

This method would allow accurate local thresholds to be defined owing to the employment of a variable spatial filter, resulting in an accurate threshold image and therefore an accurate binarized image.

(17) The method according to mode (15) or (16), further comprising a space-coded-image calculation step of calculating a space-coded image from the binarized image, based on the binarized image, according to a predetermined space-encoding algorithm.

This method would allow accurate local thresholds to be defined owing to the employment of a variable spatial filter, resulting in an accurate binarized image and therefore an accurate space-coded-image.

(18) The method according to mode (17), further comprising a three-dimensional-location calculation step of calculating as the three-dimensional information pertaining to the object, three-dimensional locations of a plurality of pixels forming the object, based on the calculated space-coded image.

This method would allow the 3-D locations of points on an object to be measured by the space-encoding technique.

(19) A computer-executable program which, when executed by a computer, effects the method according to any one of modes (1)-(18).

This program, upon executed by a computer, would provide basically the same functions and effects according to the basically the same principle, as the method according to any one of the above modes (1)-(18).

The “program” set forth in the present mode may be interpreted to incorporate not only a set of instructions implemented by a computer to perform the functions of the program, but also files, data, etc., processed according to the instructions.

In addition, this program may be interpreted as one achieving the intended purpose by being solely executed by a computer, or one achieving the intended purpose by being executed by a computer together with other program(s). In the latter case, this program may be constructed mainly with data.

(20) A computer-readable medium having stored therein a program according to mode (19).

The program which has been stored in this medium, upon executed by a computer, provides the same functions and effects as the method according to any one of the above modes (1)-(18).

This medium may be realized in different types, including a magnetic recording medium, such as a flexible-disc, an optical recording medium such as a CD and a CD-ROM, an optical-magnetic recording medium such as an MO, an un-removable storage such as a ROM, for example

(21) An apparatus of obtaining three-dimensional information pertaining to an object of interest, based on a light-pattern image acquired by digitally photographing the object with spatially patterned light being projected onto the object, the apparatus comprising:

a spatial-filter configuration circuit adapted to configure a local adaptive spatial-filter for the light-pattern image, based on a spatial frequency characteristic of the light-pattern image having a plurality of sub-areas, on a sub-area-by-sub-area basis; and

a threshold setting circuit adapted to set local thresholds for the light-pattern image, based on image information acquired by locally applying the spatial filter to the light-pattern image, on a sub-area-by-sub-area basis, wherein the local thresholds are applicable to the respective sub-areas of the light-pattern image for obtaining the three-dimensional information pertaining to the object.

This apparatus would provide basically the same functions and effects according to the basically the same principle, as the method according to the above mode (1).

(22) A computer-readable medium having stored therein a program which, when executed by a computer, obtains three-dimensional information pertaining to an object of interest, based on a light-pattern image acquired by digitally photographing the object with spatially patterned light being projected onto the object,

the program comprising:

instructions for configuring a local adaptive spatial-filter for the light-pattern image, based on a spatial frequency characteristic of the light-pattern image having a plurality of sub-areas, on a sub-area-by-sub-area basis; and

instructions for setting local thresholds for the light-pattern image, based on image information acquired by locally applying the spatial filter to the light-pattern image, on a sub-area-by-sub-area basis, wherein the local thresholds are applicable to the respective sub-areas of the light-pattern image for obtaining the three-dimensional information pertaining to the object.

The program which has been stored in this medium, upon executed by a computer, provides the same functions and effects as the method according to the above mode (1).

Several presently preferred embodiments of the invention will be described in more detail by reference to the drawings in which like numerals are used to indicate like elements throughout.

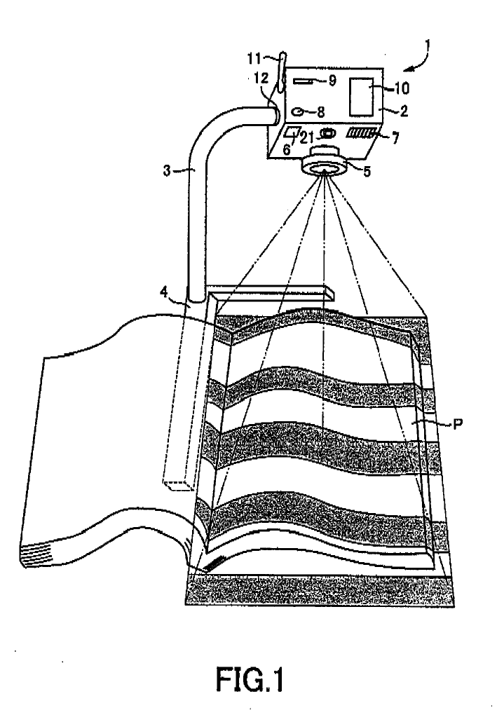

Referring first to FIG. 1, an image input/output device 1 is shown in perspective view, which is suitable for use in implementing a three-dimensional (3-D) information acquisition method in accordance with an exemplary embodiment of the present invention.

General Overview

The image Input/output device 1 is configured to perform:
(a) two types of light projection,
   a first type- normal projection, that is to say, display-image projection of imaging light (referred to also as “image-signal light”) representative of a to-be-displayed image onto a projection plane (eg., a flat surface, a display screen, a top surface of a desk, etc.), and

a second type: patterned-light projection of light-stripe patterns onto a subject to be imaged (i.e., an object of interest), that is to say, projection for acquisition of 3-D information pertaining to the subject;
(b) capturing an image of the subject or digitally photographing or imaging the subject; and

(o) computer-implemented processing of the 3-D information (including 3-D location information) of the subject, based on the captured image.

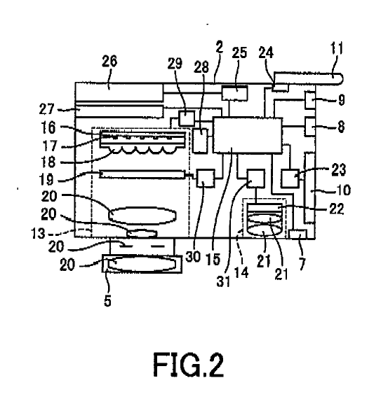

To this end, the image input/output device 1 is constructed, as shown in FIG. 2, to include a projecting section 13, an image-capturing section 14 and a processing section 15.

This image input/output device 1 operates in accordance with a user-selected one of a plurality of different operational-modes. These modes include:

a digital camera mode in which this image input/output device 1 functions as a digital camera;

a webcam mode in which this image input/output device 1 functions as a web camera;

a stereoscopic-image mode in which the 3-D shape of a subject is detected thereby creating its stereoscopic image; and

a flattened-image mode in which the stereoscopic image of a subject (such as a curved or warped document) is flattened thereby creating a flattened image of the subject.

In FIG. 1, this image input/output device 1 is shown which is situated specially in the stereoscopic-image mode or the flattened-image mode, such that, for detection of the 3-D shape of a document P as an exemplary subject to be imaged, a light-stripe pattern having alternating bright and dark portions is projected from the projecting section 13 onto the document P.

Hardware Configuration

As shown in FIG. 1, this image input/output device 1 is configured to include therein: an image-capturing head 2 generally box-shaped; a pipe-like arm member 3 which is attached at its one end to the image-capturing head 2: and a base 4 which is attached to the opposite end of the arm member 3, wherein the base 4 is generally L-shaped in plan view. The arm member 3 and the base 4 coact as a stand which holds the image-capturing head 2 by coupling in cantilever fashion thereto.

As shown in FIG. 2, the image-capturing head 2 is constructed to have its casing accommodating the projecting section 13, the image-capturing section 14 and the processing section 15. As shown in FIG. 1, this image-capturing head 2 includes therein a lens barrel 5, a finder 6 and a flashlight 7, each of which is situated so as to have its partial exposed-area positioned at the front face of the image-capturing head 2.

This image-capturing head 2 further includes therein an image-capture optical system 21 which constitutes part of the image-capturing section 14, wherein the image-capture optical system 21 has lenses, part of which has its exposed area positioned at the front face of the image-capturing head 2. The image-capture optical system 21 receives at its exposed area, external light representative of the real image of a subject.

The lens barrel 5, as shown in FIG. 1, is partially protruded from the front face of the image-capturing head 2, while including therein, as shown in FIG. 2, a projection optical system 20 which constitutes part of the projecting section 13.

This lens barrel 5 holds the projection optical system 20 such that the projection optical system 20 is entirely movable for enabling focus adjustment, while protecting the projection optical system 20 from being damaged.

At an exposed end face of the lens barrel 5, there is exposed part of lenses included in the projection optical system 20, which constitutes part of the projecting section 13. In operation, the projection optical system 20, which has its exposed area, projects or emits from the exposed area the imaging light toward the aforementioned projection plane, or patterned light toward a subject to be imaged.

The finder 6 is constructed with optical lenses disposed to direct incoming light from the front side of the image-capturing head 2 to its back side. The construction of the finder 6 permits a user, when looking into the finder 6 from the back side of the image input/output device 1, to perceive a target image in a region of and within the finder 6, which is generally equal in position to the target image focused onto a Charge Coupled Device (CCD) 22 of the image-capture optical system 21. In this regard, the CCD 22 defines an image plane, and is an exemplary image sensor.

The flashlight 7, which acts as a light source to emit light to supplement shortage amount of light, for example, in the digital-camera mode, is constructed with a discharge tube filled with Xe gas. Thus, this flashlight 7 can be reused due to repeated electric discharges of a capacitor (not shown) built in the image-capturing head 2.

The image-capturing head 2 further includes a release button 8, a mode selection switch 9 and a monitoring LCD 10 all disposed on the top face of the image-capturing head 2.

The release button 8 is manipulated by a user to activate the image input/output device 1. This release button 8 is of a two-phase pushbutton type allowing this release button 8 to generate different commands between when the user depresses this release button 8 in a “half-depressed state” and when depressing in a “fully-depressed state.”

The status of the release button 8 is monitored by the processing section 15. Upon detection of the “half-depressed state” of the release button 8 by the processing section 15, well-known features of auto-focus (AF) and auto-exposure (AE) start to automatically adjust the lens focus and aperture and the shutter speed.

In contrast, upon detection of the “fully-depressed state” of the release button 8 by the processing section 15, operations such as image-capturing start.

The mode selection switch 9 is manipulated by a user to set the operational mode of the image input/output device 1, to one of a plurality of modes including the above-mentioned digital-camera mode, webcam mode, stereoscopic-image mode and flattened-image mode, an OFF mode, etc.

The status of this mode selection switch 9 is monitored by the processing section 15. Upon detection of a current status of the mode selection switch 9 by the processing section 15, desired processing is performed for the image input/output device 1 in an operational mode corresponding to the detected status of this mode selection switch 9.

The monitoring LCD 10, in construction, includes a Liquid Crystal Display (LCD), and, in operation, displays desired images to a user in response to reception of an image signal from the processing section 15. This monitoring LCD 10 displays, for example, a captured image when the digital-camera mode or the webcam mode is selected, an image of 3-D shape detection result when the stereoscopic-image mode is selected, a flattened image when the flattened-image mode is selected, etc.

As shown in FIG. 1, the image-capturing head 2 further includes an antenna 11 acting as a Radio-Frequency (RF, i.e., wireless) interface, and a coupling member 12 physically coupling the image-capturing head 2 and the arm member 3 to each other.

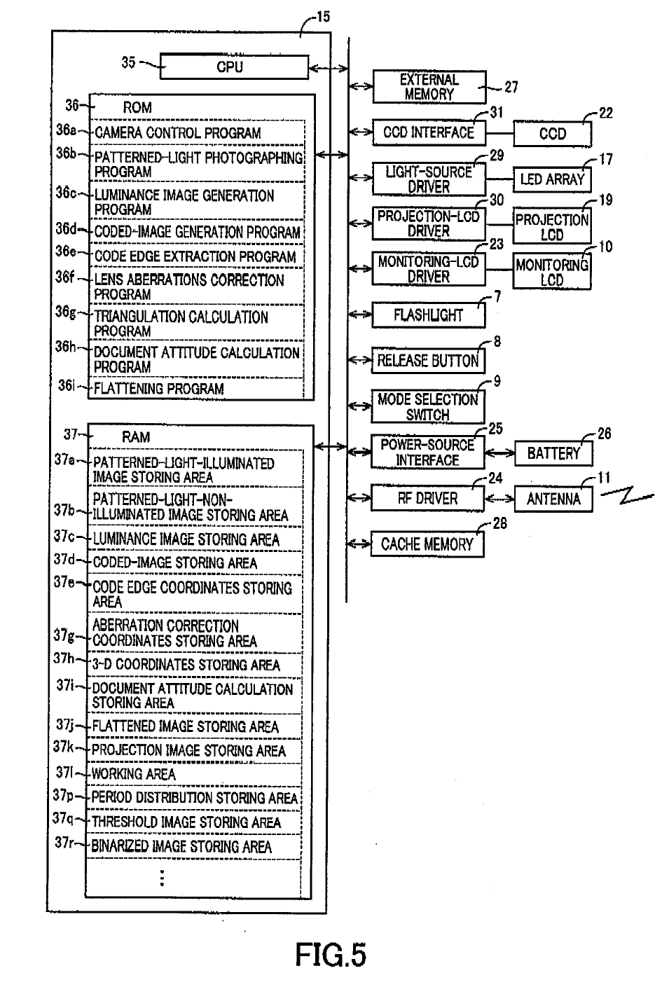

The antenna 11 is electrically connected to an RP driver 24, as shown in FIG. 5. This antenna 11 transmits data of a captured image in the digital-camera mode, data of a stereoscopic image acquired in the stereoscopic-image mode, etc., to an external interface (not shown) via the RF driver 24 by wireless.

The coupling member 12 physically couples one end of the arm member 3 to the image-capturing head 2 by a conventional screw mechanism, detachably and adjustably in the relative attachment angle between the image-capturing head 2 and the arm member 3.

More specifically, this coupling member 12, for example, in the form of an annular ring having a female-screw-formed inner circumference, is supported at one of lateral side faces of the image-capturing head 2, rotatably relative thereto and undetachably therefrom. For engagement with the female screw, a male screw is formed on one end of the arm member 3.

The screwed engagement of the male screw into the female screw allows detachable coupling between the image-capturing head 2 and the arm member 3. Thus, a user can use the image-capturing head 2 as a conventional digital camera, by detaching the image-capturing head 2 from the arm member 3. Further, the screwed engagement of the male screw into the female screw allows the image-capturing head 2 to be fixed relative to the one end of the arm member 3 at any desired relative angle.

As shown in FIG. 1, the arm member 3 is formed with a material or a mechanism which is flexibly bendable into any desired shape and which does not restore in shape without any external force applied (i.e., self-supporting). The configuration allows the arm member 3 to hold the image-Capturing head 2 being attached to the arm member 3, at a position and in an orientation both arbitrarily adjustable. This arm member 3 is formed with, for example, a bellows pipe flexibly bendable or collapsible into any desired shape.

As shown in FIG. 1, the base 4 is physically coupled to the opposite end of the arm member 3, as described above. This base 4, which is placed on a support table such as a desk, is in support of the image-capturing head 2 and the arm member 3. This base 4 can support the image-capturing head 2 and the arm member 3 with a high stability for the weight of the base 4, because the base 4 is generally L-shaped in plan view.

Further, the arm member 3 and the base 4, owing to their detachable coupling, can be detached from each other prior to, for example, their transfer or storage, which provides the function of deforming the integral shape of the arm member 3 and the base 4 into any desired shape, allowing facilitation of easy enhancement of the ease-to-transfer and an easy reduction in storage space required.

Referring next to FIG. 2, the interior configuration of the image-capturing head 2 is shown conceptually. The image-capturing head 2 incorporates therein the projecting section 13, the image-capturing section 14 and the processing section 15 as major components, as described above.

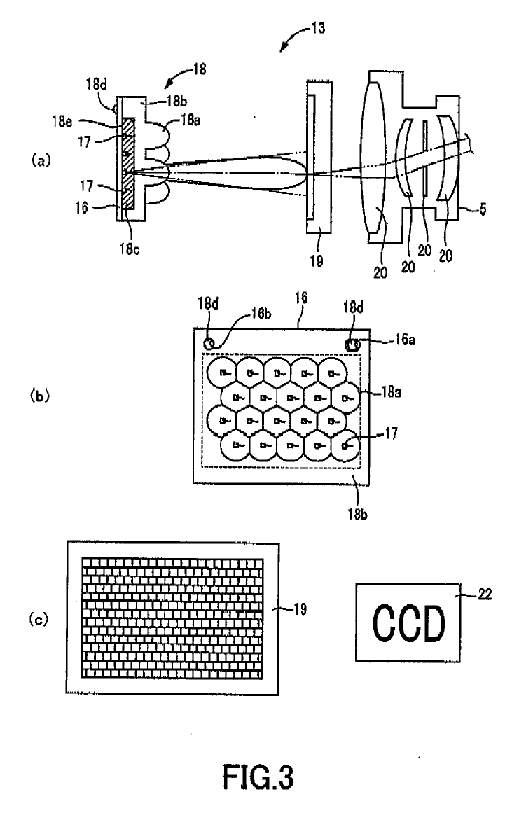

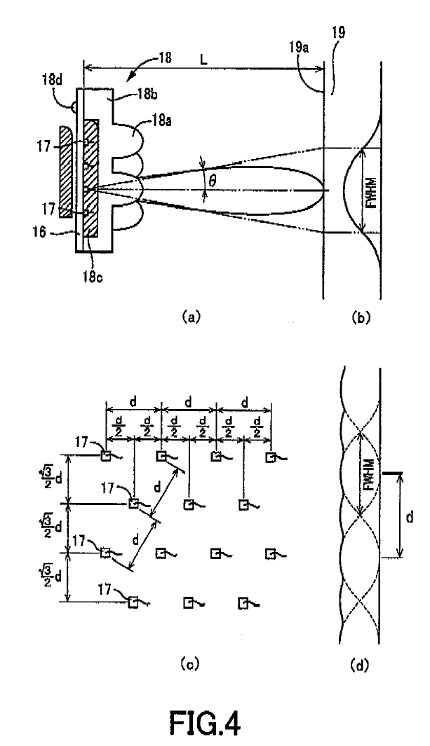

The projecting section 13 is a unit for use in projecting any desired imaging light (indicative of a display image) onto a projection plane, or patterned light onto a subject to be imaged. As shown in FIG. 2, this projecting section 13 includes therein; a substrate 16, a plurality of LEDs 17 (hereinafter, collectively referred to as “LED array 17A”), a light-source lens 18 and a projection LCD 19; and the aforementioned projection optical system 20, all in series along a projection direction. This projecting section 13 will be described later on in more detail by referring to FIG. 3.

The image-capturing section 14 is a unit for use in capturing an image of the document P which acts as a subject to be imaged. As shown in FIG. 2, this image-capturing section 14 includes therein the image-capture optical system 21 and the CCD 22 in series in a direction of incidence of external light representative of the real image of a subject.

As shown in FIG. 2, the image-capture optical system 21 is constructed with a series of lenses, In operation, this image-capture optical system 21 adjusts the focal length and the aperture of the lenses automatically, using a well known auto-focus feature, resulting in the imaging of the externally incoming light on the CCD 22.

The CCD 22 is configured with a matrix array of photo-electric elements such as photodiode elements. In operation, this CCD 22 generates pixel-by-pixel signals indicative of an image focused onto the surface of this CCD 22 via the image-capture optical system 21, wherein the signals are indicative of colors and intensities of light forming the focused image. The generated signals, after conversion into digital data, are outputted to the processing section 15.

Software Configuration

As shown in FIG. 5 in block diagram, the processing section 15 is connected electrically to the flashlight 7, the release button 8 and the mode selection switch 9, respectively. This processing section 15 is further connected electrically to the monitoring LCD 10 via a monitoring-LCD driver 23, to the antenna 11 via the RF driver 24, and to a battery 26 via a power-source interface 25, respectively.

This processing section 15 is additionally connected electrically to an external memory 27 and a cache memory 28, respectively. This processing section 15 is still additionally connected electrically to the LED array 17A via a light-source driver 29, to the projection LCD 19 via a projection-LCD driver 30, and to the CCD 22 via a CCD interface 31, respectively. The above-listed connected-components beginning with the flashlight 7 are controlled by the processing section 15.

The external memory 27 is in the form of a removal flash-ROM which can store captured images in the digital-camera mode and the webcam mode, and also in the stereoscopic-image, and 3-D information. The external memory 27 may be prepared as a marketed device such as a SD card or a Compact Flash (registered trademark) card.

The cache memory 28 Is a memory device enabling high-speed read and write of data. In an exemplary application, the cache memory 28 is used for transferring images captured in the digital-camera mode to the cache memory 28 at a high speed, and storing the transferred image in the external memory 27, after implementing desired image-processing. The cache memory 28 may be prepared as a conventional memory device such as a SDRAM or a DDRRAM.

The power-source interface 25, the light-source driver 29, the projection-LCD driver 30 and the CCD interface 31 are constructed as Integrated Circuits (ICs) which control the battery 26, the LED array 17A, the projection LCD 19 and the CCD 22, respectively.

Now, the projecting section 13 will be described in more detail by referring to FIG. 3.

FIG. 3(a) is an enlarged view of the projecting section 13, FIG. 3(b) is a front view of the light-source lens 18, and FIG. 3(c) is a front view to explain the relative geometry between the projection LCD 19 and the CCD 22 in arrangement.

As described above, the projecting section 13, as shown in FIG. 3(a), includes therein the substrate 16, the LED array 17A, the light-source lens 18, the projection LCD 19 and the projection optical system 20 in series in a projection direction of patterned light.

The substrate 16, owing to its attachment to the LED array 17A, provides electrical wirings between the substrate 16 and the LED array 17A. The substrate 16 may be fabricated using, for example, an aluminum-made substrate to which an insulating synthetic resin is applied and thereafter a conductive pattern is formed by electroless plating, or using a single- or multi-layered substrate having a core LO in the form of a glass-epoxy base material.

The LED array 17A is a light source which emits radiant light toward the projection LCD 19. In this LED array 17A, as shown in FIG. 3(b). a plurality of light emitting diodes (LEDs) 17 are adhesively bonded to the substrate 16 via silver paste in a staggered array. The substrate 16 and the plurality of LEDs 17 are electrically wired to one another via suitable bonding wires. The advantages achieved by the staggered array of the plurality of LEDs 17 will be described later on in more detail by referring to FIG. 4.

Thus, in the present embodiment, the selection of the plurality of LEDs 17 as the light source of the projecting section 13 makes it easier to improve electro-optical conversion efficiency, and to suppress derivative infrared or ultra violet, than when an incandescent lamp or a halogen bulb is selected as the light source. This therefore results in saved energy consumption, elongated life time, suppressed heat-generation. etc., of the image input/output device 1.

Thus, each LED 17 has a far lower generation-rate of heat ray than those of a halogen bulb or the like, enabling employment of synthetic-resin-made lenses for preparing the light-source lens 18 and the projection optical system 20. Therefore, the employment of synthetic-resin-made lenses allows the light-source lens 18 and the projection optical system 20 to be manufactured for a lower cost and with a lower weight than when glass-made lenses are employed.

Further, in the present embodiment, the individual LEDS 17 collectively forming the LED array 17A emit light beams having a common color, in other words, more specifically, an umber color produced from the material using four elements Al, In, Ga and P.

Thus, in the present embodiment, there is no need to concern about correction for chromatic aberrations or distortion, which is an essential concern raised when the LED array 17A is alternatively configured to emit light beams different in color, and there is also no need for employment of achromatic lens in the projection optical system 20 for correction for chromatic aberrations or distortion. As a result, the flexibility in designing the projection optical system 20 can be improved.

Further, in the present embodiment, an umbered-light-emission-type LED is employed which is made up of the aforementioned four-element material. This LED achieves electro-optical conversion efficiency as high as about 80 [lumen/W], which out performs other LEDs each emitting a different-colored light beam. This makes it easier to achieve high luminance or brightness, saved energy consumption and elongated life time, of the image input/output device 1.

More specifically, in the present embodiment, the LED array 17A is comprised of fifty-nine LEDs 17. Each LED 17 is driven by 50 [mW] (20 [mA], 2.5 [V]) of power, with a resulting total power consumption of generally 3 [W] for driving all the fifty-nine LEDs 17.

Further, in the present embodiment, the amount of light emitted from each LED 17 is configured such that a luminous flux measured at the exit of the projection LCD 19 into which the light emitted from each LED 17 is entered after passing through the light-source lens 18 and the projection LCD 19, is on the order of 25 ANSI lumens even when the LED array 17A is activated in full-illumination mode.

In the present embodiment, the thus-established amount of light emitted from the projecting section 13 of the image input/output device 1 prevents a subject, for example, when it includes a face of a human or an animal, from being dazzled by discomfort glare from the projecting section 13, even in the stereoscopic-image mode in which the patterned light is projected onto the subject for detection of its 3-D shape.

The present embodiment, therefore, makes it easier for a subject, when it is a human or an animal, to keep the eyes open during the detection of the 3-D shape of the subject.

As shown in FIG. 3, the light-source lens 18 is a lens which acts to converge radiant light emitted from the LED array 17A, and which is made up of optical plastics typified by acrylic plastics.

As shown in FIG. 3(a), the light-source lens 18 includes: a plurality of ridged lens portions 18a; a base portion 18b in support of the lens portions 18a; epoxy resin sealant 18c; and a plurality of locator pins 18d.

As shown in FIG. 3(a), each lens portion 18a is disposed on the base portion 18b in facing relation to a corresponding one of the plurality of LEDs 17 included in the LED array 17A, so as to protrude from the base portion 18b toward the projection LCD 19.

The epoxy resin sealant 18c is filled in a recessed portion 18eof the base portion 18b within which the LED array 17A is to be housed in air-tight relation to the base portion 18b, resulting in encapsulation of the LED array 17A within the recessed portion 18e. That is to say, this epoxy resin sealant 18c functions to provide an air-tight seal with the LED array 17A, and also perform adhesive bonding between the substrate 16 and the light-source lens 18.

As shown in FIG. 3(a), the plurality of locator pins 18d are disposed on the light-source lens 18 so as to protrude therefrom toward the substrate 16, for locating or positioning the light-source lens 18 relative to the substrate 16. As shown in FIG. 3(b), some of the plurality of locator pins 18d are inserted in elongated holes 16b formed through the substrate 16, while the remaining locator pin(s) 18d is inserted in regular-circle hole(s) 16b formed through the substrate 16, thereby fixedly securing the light-source lens 18 to the substrate 16 at a regular position without any play.

As will be evident from the above, in the present embodiment, the light-source lens 18, the LED array 17A and the substrate 16 are stacked or laminated in a projection direction so as to be closely spaced apart from one another, allowing an assembly of the above-listed components beginning with the light-source lens 18 to be compactified and become space-saving with greater ease.

Further, in the present embodiment, the substrate 16 has a basic function of holding the LED array 17A and an additional and supplemental function of holding the light-source lens 18. The present embodiment, therefore, makes it unnecessary to add to the image input/output device 1 a component for exclusively holding the light-source lens 18, allowing facilitation of an easy reduction in the number of components of the image input/output device 1.

Still further, in the present embodiment, as shown in FIG. 3(a), the individual lens portions 18a are arranged in direct facing relation to the LEDs 17 of the LED array 17A in one-to-one correspondence. This arrangement allows radiant light emitted from each LED 17 to be efficiently converged or collected by the corresponding lens portion 18a located in direct facing relation to each LED 17, and to be incident on the projection LCD 19 such that the light is in the form of radiant light with enhanced directivity, as shown in FIG. 3(a).

The reason why the incident light is configured to enhance its directivity is that, when light is incident on the projection LCD 19 generally at a right angle relative to a light entry surface thereof, the projection LCD 19 is improved in nonuniformity of light-transmittances occurring in the light entry surface, possibly leading to enhanced quality of image.

The projection optical system 20 is comprised of a plurality of lenses for use in directing or projecting incoming light from the projection LCD 19 toward the projection plane or a subject to be imaged. The plurality of lenses are of a telecentric configuration formed by combining glass lens(es) and synthetic-resin lens(es). The telecentric configuration enables principle rays passing through the projection optical system 20 to travel in parallel to its optical axis on the entrance side, and to define its output pupil at infinity.

As described above, the projection optical system 20 has a telecentric characteristic featured by an entrance numerical-aperture (NA) on the order of 0.1. An available optical path in the projection optical system 20, accordingly, is limited so as to allow light, only in the presence of an incidence angle of ±5 degrees from normal, to pass through an internal aperture stop within the projection optical system 20.

In the present embodiment, the telecentric configuration of the projection optical system 20 allows facilitation of easy improvement of image quality, in cooperation with an additional configuration which allows light passing through the projection LCD 19, only in the presence of an incidence angle of ±5 degrees from normal, to be projected onto the projection optical system 20.

Therefore, in the present embodiment, for image quality to be improved, outgoing light beams from the individual LEDs 17 are required to be equalized in angle with one another such that an outgoing light beam from each LED 17 is incident on the projection LCD 19 generally perpendicularly, and additionally, most of an outgoing light beam from each LED 17 is required to be incident on the projection optical system 20 at an incidence angle of ±5 degrees from normal.

As shown in FIG. 3(c), the projection LCD 19 is in the form of a spatial light modulator which applies desired spatial modulation to light converged due to the passage through the light-source lens 18, thereby generating patterned light. The spatial light modulator further outputs the patterned light toward the projection optical system 20. More specifically, the projection LCD 19 is in the form of a panel-shaped LCD having an aspect ratio not equal to 1:1.

As shown in FIG. 3(e), this projection LCD 19 is made up of a plurality of pixels which are in a staggered planar-array on a single flat plane.

More specifically, there are juxtaposed pixel linear-arrays in this projection LCD 19, each of which is formed by a sub-plurality of the plurality of pixels which are equally spaced at a predetermined pixel-pitch in a linear array extending in the lengthwise direction (i.e., lateral direction) of the LCD panel,

In this staggered planar-array, adjacent two of the pixel linear-arrays are staggered relative to each other in the lengthwise direction of the LCD panel, by a distance smaller than the pixel pitch.

In the present embodiment, owing to the thus-staggered planar array of the plurality of pixels in the projection LCD 19, original light to be space-modulated by the projection LCD 19 is capable of being controlled or spatially modulated in the lengthwise direction of the projection LCD 19, in steps equal to one-half the aforementioned pixel pitch.

The present embodiment, therefore, allows the control or spatial modulation of to-be-projected patterned light in fine pitch-steps, resultantly allowing the detection of the 3-D shape of a subject with high definition and high accuracy.

More specifically, the image input/output device 1 is configured, as shown in FIG. 1, to allow a striped pattern of light having alternating bright portions and dark portions to be projected onto a subject for detection of its 3-D shape, in particular in the stereoscopic-image mode and the flattened-image mode as described below in more detail.

In the present embodiment, the patterned light is pre-defined in orientation such that the direction in which a plurality of stripes (including bright portions (illuminated stripes) and dark portions (non-illuminated or shadowed stripes)) are arrayed is coincident with 10 the lengthwise direction of the projection LCD 19. The direction of the stripe array is coincident with the widthwise direction of each stripe.

As a result, in the present embodiment, the image input/output device 1 is capable of controlling the positions of borders between 15 adjacent ones of the bright and dark portions in the patterned light, in steps equal to the aforementioned one-half pitch distance, resultantly allowing the accurate detection of the 3-D shape of a subject, in the stereoscopic-image mode and the flattened-image mode.

The projection LCD 19 and the CCD 22, which are shown in FIG. 3(c) so as to form a horizontal linear array, are disposed, with the front face of the image-capturing head 2 being located on the near side of the sheet of this figure, so that light coming from the far side of the sheet can enter the projection LCD 19, while light coming from the near side of the sheet can enter the CCD 22, resulting in the creation of an image of a subject.

The projection LCD 19 and the CCD 22 are disposed within the image-capturing head 2 in the layout shown in FIG. 3(c). More specifically, the projection LCD 19 and the CCD 22 are disposed such that their principle faces (i.e., large-width faces) are oriented in generally the same direction.

As a result, in the present embodiment, for detection of the 3-D shape of a subject by causing the projection LCD 19 to project patterned light onto the subject and subsequently causing light reflected from the subject to be focused onto the CCD 22 within the image input/output device 1, a single straight -line extending through both centers of the projection LCD 19 and the CCD 22 can be employed as one of the three sides of a triangle for use in computational triangulation.

In addition, the CCD 22 is disposed apart from the projection LCD 19 in its lengthwise direction (i.e., the direction in which the aforementioned pixel linear-arrays elongate).

As a result, for detection of the 3-D shape of a subject based on the principle of triangulation, in particular in the stereoscopic-image mode and the flattened-image mode, the:inclination between the CCD 22 and the subject can be controlled in steps equal to the aforementioned one-half pitch distance, resultantly allowing the accurate detection of the 3-D shape of a subject, similarly with the above.

In the present embodiment, the employment of the staggered planar-array as a specific pixel-arrangement in the projection LCD 19 allows the creation of a special light-pattern in addition to a plurality of standard light-patterns prepared without relying on the staggered planar-array.

In this regard, the plurality of standard light-patterns are each formed such that a plurality of stripes are arrayed at intervals equal to pixel intervals in which pixels are arrayed in each linear array of pixels. In contrast, the special light-pattern is formed such that a plurality of stripes are arrayed at intervals smaller than the smallest one of the pixel intervals occurring in the respective standard light-patterns.

As a result, in the present embodiment, when there are N standard light-patterns, an (N+b 1)-bit space-code is available. This also allows the accurate detection of the 3-D shape of a subject.

For these reasons, in the present embodiment, a space code is available which has many bits for the length of intervals at which pixels are arrayed in the projection LCD 19, that is to say, the level of resolution or definition provided by the projection LCD 19.

Referring next to FIG. 4, the arrangement of the LEDs 17 in the LED array 17A will be described below in more detail.

FIG. 4(a) is a side view showing the 3-D shape of a light beam emitting from the light-source lens 18. FIG. 4(b) is a graph showing the illuminance distribution of a light beam leaving any one of the plurality of LEDs 17 and then impinging on a light entry surface 19a of the projection LCD 19.

FIG. 4(c) is a front view fragmentally showing the arrangement of the LEDs 17 in the LED array 17A in enlargement. FIG. 4(d) is a graph showing the composite illuminance distribution of a plurality of light beams leaving the plurality of LEDs 17 and then impinging together on the light entry surface 19a of the projection LCD 19.

The light-source lens 18 is configured so that outgoing light therefrom can reach the light entry surface 19a of projection LCD 19, such that the outgoing light has a half spread-angle θ at half maximum generally equal to 5.degree., and has the illuminance distribution as shown in FIG. 4(b).

In addition, as shown in FIG. 4(c), the plurality of LEDs 17 are in a staggered planar-array on the substrate 16, in conformity with the staggered planar-array of the pixels in the projection LCD 19.

More specifically, there are juxtaposed LED linear-arrays, each of which is formed by a sub-plurality of the plurality of LEDs 17 which are laterally spaced at a pitch d In series. The LED linear-arrays are vertically spaced at a pitch equal to the product of the square root of “3/2” and the pitch d.

Additionally, vertically adjacent two of the LED linear-arrays are laterally staggered relative to each other a distance equal to the pitch d.

As a result, in the present embodiment, the plurality of LEDs 17 are in a triangular-grid array, allowing any pair of adjacent twos of the LEDs 17 to be spaced apart a distance equal to the pitch d.

Additionally, in the present embodiment, the pitch d is pre-set to a length equal to or smaller than the Full Width Half Maximum (FWHM) of the illuminance distribution provided by outgoing light from one of the LEDs 17 to the projection LCD 19.

Therefore, in the present embodiment, as shown in FIG. 4(d), the composite illuminance distribution of composite light reaching the light entry surface 19a of the projection LCD 19 after passing through the light-source lens 18 is provided so as to be graphed by such a generally-straight line that indicates reduced ripple, allowing the entire light-entry-surface 19a of the projection LCD 19 to be generally uniformly illuminated.

As a result, in the present embodiment, illuminance nonuniformity in the projection LCD 19 is so suppressed that imaging light is projected onto the projection plane with high quality, and that patterned light is projected onto a subject with high quality.

Referring next to FIG. 5, the electric configuration of the image input/output device 1 is shown in block diagram.

The processing section 15 is configured to include as a major component a computer which is constructed to incorporate therein a Central Processing Unit (CPU) 35, a Read Only Memory (RON) 36 and a Random Access Memory (RAM) 37.

The CPU 35 executes programs stored in the ROM 36 while using the RAM 37, thereby performing various sets of processing such as the detection of the status of the release button 8, the retrieval of image data from the CCD 22, the transfer and storage of the retrieved image-data; the detection of the status of the mode selection switch 9, etc.

The ROM 36 has stored therein a camera control program 36a, a patterned-light photographing program 36b, a luminance image generation program 36c, a coded-image generation program 36d, a code edge extraction program 36e, a lens aberrations correction program 36f, a triangulation calculation program 36g, a document attitude calculation program 36h and a flattening program 36i.

Main Operation

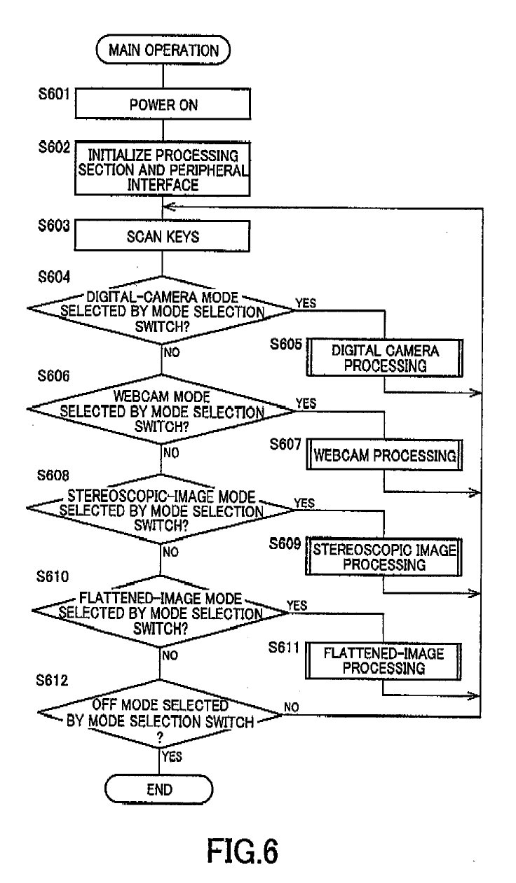

The camera control program 36a is executed to perform the total control of the image input/output device 1, wherein the total control includes a main operation conceptually shown in FIG. 6 in flow chart.

The patterned-light photographing program 36b is executed to photograph a subject or a document P, while being illuminated by a light pattern (i.e., projection pattern), for detection of the 3-D shape of the document P, thereby acquiring a corresponding patterned-light-illuminated image, and also photograph the same subject, while being not illuminated by a light pattern, thereby acquiring a corresponding patterned-light-non-illuminated image.

The luminance image generation program 36c is executed to calculate the difference between the patterned-light-illuminated image and the patterned-light-non-illuminated image, both acquired for the same subject by execution of the patterned-light photographing program 36b, thereby generating a luminance image representative of the subject illuminated by the patterned light.

In the present embodiment, a plurality of different light-patterns are successively projected onto the same subject, and the subject is imaged or digitally photographed each time each light pattern is projected onto the subject, thereby obtaining a plurality of respective patterned-light-illuminated images.

In other words, in the present embodiment, time-modulated illumination patterns (i.e., two-dimensionally-structured patterns) are used for projecting a sequence of coded patterns onto a subject, thereby acquiring the 3-D shape of the subject.

Further, the difference is calculated between each of the thus-obtained patterned-light-illuminated images and the patterned-light-non-illuminated image, eventually resulting in the generation of a plurality of luminance images having the same total-number as that of the light patterns.

The coded-image generation program 36d is executed to generate from binarized images, a coded image having space codes allocated to respective pixels of the coded image. The binarized images are generated as a result of the thresholding of individual luminance-images which are generated as a result of the execution of the luminance image generation program 36c.

Described schematically, upon initiation of this coded-image generation program 36d, a representative one of the plurality of luminance images is selected which was obtained when a subject was illuminated by one of the plurality of light patterns which has the smallest pitch distance between adjacent patterned lines (i.e., stripes) among those of the plurality of light patterns.

Further, variable distances between adjacent twos of the patterned lines in the representative luminance-image are calculated as spacings or periods (i.e., cycle times), and the distribution of the calculated periods over the entire representative luminance-image is calculated as a period distribution.

Upon initiation of this coded-image generation program 36d, additionally, a local moving-window is provided in common to the luminance images associated with different light-patterns, so as to have a size variable along the profile of the calculated period-distribution of the representative luminance-image, thereby filtering the entire representative luminance-image using the thus-provided variable-width window.

The filtering is performed for calculating and determining local thresholds over the entire representative luminance-Image, thereby generating a threshold image indicative of the distribution of the thus-determined thresholds. From the relation between the thus-generated threshold image and each of the different luminance-images, binarized images are generated on a light-pattern-by-light-pattern basis.

The code edge extraction program 36e is executed to calculate code edge coordinates (coordinates of edges separating uniform coded-areas) with sub-pixel accuracy, by the use of both a coded image generated by the execution of the coded-image generation program 36d and the luminance images generated by the execution of the luminance image generation program 36c.

The lens aberrations correction program 36f is executed to process the code edge coordinates generated with sub-pixel accuracy by the execution of the code edge extraction program 36 for correction for aberrations or distortion due to the image-capture optical system 20.

The triangulation calculation program 36g is executed to calculate from the code edge coordinates which have been aberrations-corrected by the execution of the lens aberrations correction program 36f, 3-D coordinates defined in a real space which correspond to the aberrations-corrected code edge coordinates.

The document attitude calculation program 36h is executed to determine by estimation the 3-D shape of the document P, from the 3-D coordinates calculated by the execution of the triangulation calculation program 36g.

The flattening program 36i is executed to generate a flattened image of the document P such as an image captured as if the document P were orthogonally photographed, based on the 3-D shape of the document P calculated by the execution of the document attitude calculation program 36h.

As shown in FIG. 5, the RAM 37 has memory areas assigned to the following:

a patterned-light-illuminated image storing area 37a;

a patterned-light-non-illuminated image storing area 37b;

a luminance image storing area 37c;

a coded-image storing area 37d;

a code edge coordinates storing area 37e:

an aberration correction coordinates storing area 37g;

a 3-D coordinates storing area 37h;

a document attitude calculation storing area 37i;

a flattened image storing area 37j;

a projection image storing area 37k;

a working area 37l;

a period distribution storing area 37p:

a threshold image storing area 37q; and

a binarized image storing area 37r.

The patterned-light-illuminated image storing area 37a is used for storage of data indicative of a patterned-light-illuminated image captured as a result of the execution of the patterned-light photographing program 36b. The patterned-light-non-illuminated image storing area 37b is used for storage of data indicative of a patterned-light-non-illuminated image captured as a result of the execution of the patterned-light photographing program 36b.

The luminance image storing area 37c is used for storage of data indicative of luminance images resulting from the execution of the luminance image generation program 36c. The coded-image storing area 37d is used for storage of data indicative of a coded image resulting from the execution of the coded-image generation program 36d. The code edge coordinates storing area 37e is used for storage of data indicative of code edge coordinates extracted with sub-pixel accuracy by the execution of the code edge extraction program 36e.

The aberration correction coordinates storing area 37g is used for storage of data indicative of the code edge coordinates processed for the aberrations correction by the execution of the lens aberrations correction program 36f. The 3-D coordinates storing area 37h is used for storage of data indicative of 3-D coordinates in the real space calculated by the execution of the triangulation calculation program 36g.

The document attitude calculation storing area 37i is used for storage of parameters related to the 3-D shape of the document P calculated by the execution of the document attitude calculation program 36h. The flattened image storing area 37j is used for storage of data indicative of the result of the flattening operation by the execution of the flattening program 36i. The projection image storing area 37k is used for storage of information related to projection images (including display-images or light patterns) which the projecting section 13 is to project onto the projection plane or a subject. The working area 37l is used for temporal storage of data to be used by the CPU 35 for its operation.

The period distribution storing area 37p, the threshold image storing area 37q and the binarized image storing area 37r are used for storage of data indicative of the period distribution, data indicative of the threshold image, and data indicative of the binarized images, all acquired by the execution of the coded-image generation program 36d.

Referring next to FIG. 6, the camera control program 36a will be described below. As a result of the execution of this program 36a by the aforementioned computer, the aforementioned main operation is performed.

This main operation starts with step S601 to power on a power source including the battery 26, which is followed by step S602 to initialize the processing section 15, a peripheral interface, etc.

Subsequently, at step S603, a key scan is performed for monitoring the status of the mode selection switch 9, and then, at step S604, a determination is made as to whether or not the digital-camera mode has been selected by the user through the mode selection switch 9. If so, then the determination becomes “YES” and operations progress to step S605 to perform digital camera processing as will be described later on.

If, however, the digital-camera mode has not been selected by the user through the mode selection switch 9, then the determination of step S604 becomes “NO” and operations progress to step S606 to make a determination as to whether or not the webcam mode has been selected by the user through the mode selection switch 9. If so, then the determination becomes “YES” and operations progress to step S607 to perform webcam processing as will be described later on.

If, however, the webcam mode has not been selected by the user through the mode selection switch 9, then the determination of step S606 becomes “NO” and operations progress to step S608 to make a determination as to whether or not the stereoscopic-image mode has been selected by the user through the mode selection switch 9. If so, then the determination becomes “YES” and operations progress to step S609 to perform stereoscopic image processing as will be described later on.

If, however, the stereoscopic-image mode has not been selected by the user through the mode selection switch 9, then the determination of step S608 becomes “NO” and operations progress to step S610 to make a determination as to whether or not the flattened-image mode has been selected by the user through the mode selection switch 9. If so, then the determination becomes “YES” and operations progress to step S611 to perform flattening image processing as will be described later on.

If, however, the flattened-image mode has not been selected by the user through the mode selection switch 9, then the determination of step 5610 becomes “NO” and operations progress to step S612 to make a determination as to whether or not the OFF mode has been selected by the user through the mode selection switch 9. If so, then the determination becomes “YES” with immediate termination of this main operation, and otherwise the determination becomes “NO” with return to step S603.

Digital Camera Processing

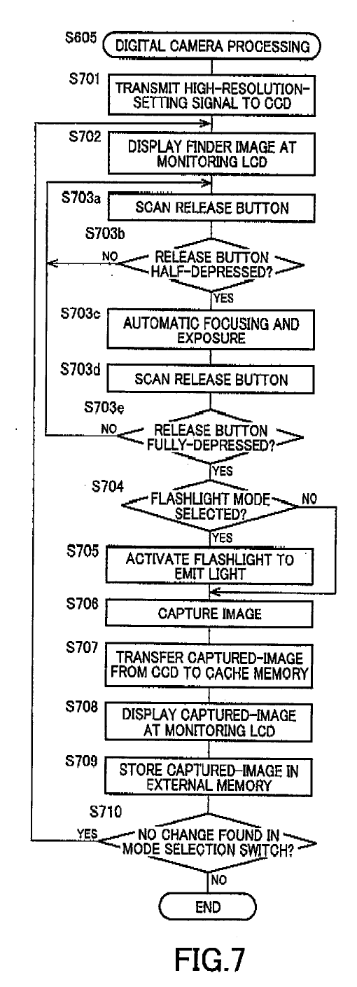

Referring next to FIG. 7, step S605 depicted in FIG. 6 is conceptually shown in flow chart as a digital camera processing routine. As a result of the execution of this routine, the digital camera processing is performed to acquire an image captured by the image-capturing section 14.

This digital camera processing routine starts with step S701 to transmit a high-resolution setting signal to the CCD 22, which provide a captured image of high quality to the user.

Next at step S702 a finder image is displayed on the monitoring LCD 10 exactly as an image which the user can view through the finder 6. This enables the user to verify a captured image (i.e., an image capture field) prior to an substantial image-capture stage, provided that the user views an image displayed on the monitoring LCD 10, without requiring the user to look into the finder 6.

Subsequently, at step S703a, the status of the release button 8 is scanned or monitored, and then, at step S703b, based on the result from the scan, a determination is made as to whether or not the release button 8 has been half-depressed.

If so, then the determination becomes “YES” and operations progress to step S703c to invoke the auto-focus function (AF) and the automated exposure function (AE), thereby adjusting the lens focus and aperture and the shutter speed. If at step S703b it is determined that the release button 8 has not been brought into the half-depressed state, then the determination becomes “NO” and operations return to step S703a.

Upon termination of step S703c, at step S703d, the status of the release button 8 is scanned again, and then, at step S703e, based on the result from the scan, a determination is made as to whether or not the release button 8 has been fully-depressed. If not, then the determination becomes “NO” and operations return to step S703a.

If, however, the release button 8 has changed from the half-depressed state into the fully-depressed state, then the determination of step S703e becomes “YES” and operations progress to step S704 to make a determination as to whether or not a flashlight mode has been selected.

If so, then the determination becomes “YES” and operations progress to step S705 to activate the flashlight 7 to emit light, and otherwise the determination of step S704 becomes “NO” and step S705 is skipped.

In any event, step S706 follows to photograph a subject (e.g., the document P). Subsequently, at step S707, a captured image obtained by digitally photographing the subject is transferred from the CCD 22 to the cache memory 28 for storage. Thereafter at step S708, the captured image which has been stored in the cache memory 28 is displayed on the monitoring LCD 10.

In the present embodiment, the captured image, because of its storage in the cache memory 28, can be displayed on the monitoring LCD 10 faster than when the captured image is transferred to a conventional main memory. Subsequently, at step S709, the captured image is stored in the external memory 27.

Step S710 follows to make a determination as to whether or not no change has been found in the status of the mode selection switch 9. If so, then the determination becomes “YES” and operations return to step S702 and otherwise the determination of step S710 becomes “NO” with termination of this digital camera processing.

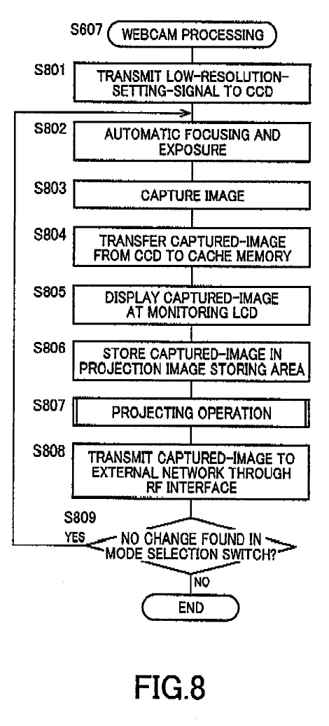

Referring next to FIG. 8, step S607 in FIG. 6 is conceptually shown in flow chart as a webcam processing routine. As a result of the execution of this routine, webcam processing is performed to transmit captured images (including still pictures and moving pictures) to an external network by the image-capturing section 14. In the present embodiment, a setting is contemplated in which moving pictures as the captured images are transmitted to the external network (not shown) such as the Internet.

This webcam processing starts with step Soot to transmit a low resolution setting signal to the CCD 22. Next, step S802 is implemented to invoke the auto-focus function (AF) and the automated exposure function (AE), thereby adjusting the lens focus and aperture and the shutter speed. Subsequently, at step S803, a subject is digitally photographed or imaged.

Thereafter, at step S804, the captured image is transferred from the CCD 22 to the cache memory 28, and then, at step S805, the captured image is displayed on the monitoring LCD 10.

Thereafter, at step S806, the captured image is stored in the projection image storing area 37k, which is followed by step S807 to perform a projecting operation (i.e., the display-image projection) as will be described later on, thereby projecting onto the projection plane the image which has been stored in the projection image storing area 37k.

Subsequently, at step S808, the captured image which has been stored in the cache memory 28 is transferred via an RF interface (not shown) to the aforementioned external network.

Thereafter, at step S809, a determination is made as to whether or not no change has been found in the status of the mode selection switch 9. If so, then the determination becomes “YES” and operations return to step S802 and otherwise this webcam processing terminates.

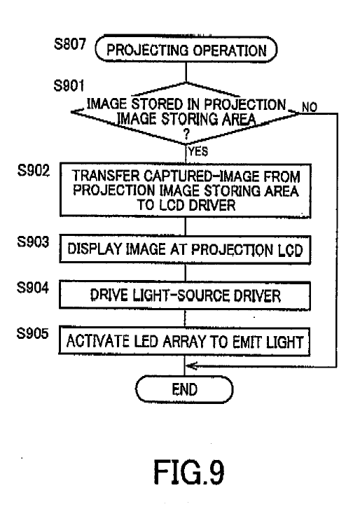

Projecting Operation Referring next to FIG. 9, step S807 in FIG. 8 is conceptually shown in flow chart as a projection routine. As a result of the execution of this routine, the projecting operation (i.e., the display-image projection) is performed to project images stored in the projection image storing area 37k, onto the projection plane from the projecting section 13.

This projecting operation starts with step S901 to make a determination as to whether or not some image(s) has been stored in the projection image storing area 37k. If not, then the determination becomes “NO” with immediate termination of this projecting operation and otherwise the determination becomes “YES” and operations progress to step S902 to transfer some image(s) which has been stored in the projection image storing area 37k to the projection-LCD driver 30.

Subsequently, at step S903, an image signal indicative of the stored image(s) is sent from the projection-LCD driver 30 to the projection LCD 19, thereby displaying image(s) on the projection LCD 19. Step S904 follows to drive the light-source driver 29 and step S905 follows to cause the LED array 17A to emit light in response to the electrical signal from the light-source driver 29. Then, this projecting operation terminates.

Light emitted from the LED array 17A reaches the projection LCD 19 through the light-source lens 18. At the projection LCD 19, the spatial modulation is applied in response to the image signal received from the projection-LCD driver 30, thereby converting light (original light) coming into the projection LCD 19 into the aforementioned image-signal light. The image-signal light is output from the projection LCD 19 and projected to form the projection image (i.e., the display image, in this context), by way of the projection optical system 20, onto the projection plane.

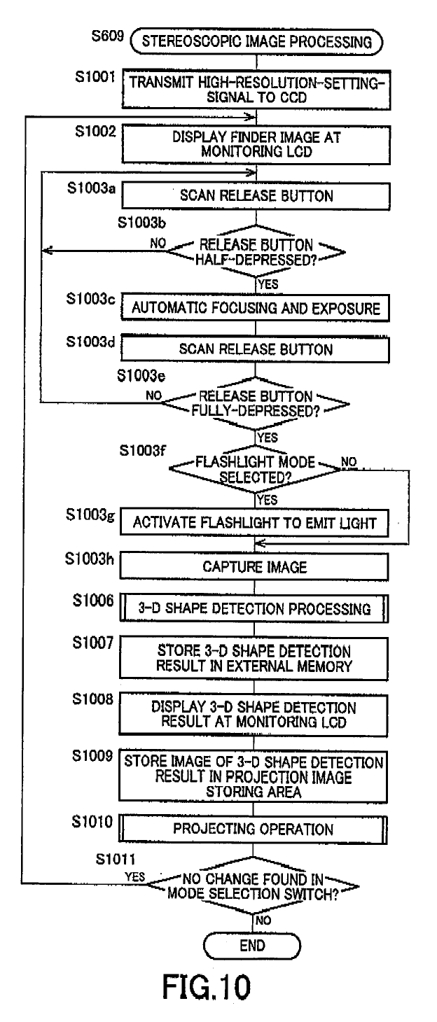

Referring next to FIG. 10, step S609 in FIG. 6 Is conceptually shown in flow chart as a stereoscopic image processing routine. As a result of the execution of this routine, stereoscopic image processing is performed in which the 3-D shape of a subject is detected, and an image of 3-D shape detection result is acquired as a stereoscopic image, displayed and projected.

Stereoscopic Image Processing

This stereoscopic image processing starts with step S1001 to transmit a high-resolution setting signal to the CCD 22. Next, steps S1002-S1003h are implemented similarly with steps S702-S706 depicted in FIG. 7.

More specifically, at step S1002, the finder image is displayed on the monitoring LCD 10, at step S1003a, the status of the release button 8 is scanned, and at step S1003b, based on the result from the scan, a determination is made as to whether or not the release button 8 has been half-depressed. If so, then the determination becomes “YES” and operations progress to step S1003c to invoke the auto-focus function (AF) and the automated exposure function (AB).

Upon termination of step S1003c, at step S1003d, the status of release button 8 is scanned again, and then, at step S1003e, based on the result from the scan, a determination is made as to whether or not the release button 8 has been fully-depressed.

If the release button 3 has changed from the half-depressed state into the fully-depressed state, then the determination of step S1003e becomes “YES” and operations progress to step S1003f to make a determination as to whether or not the flashlight mode has been selected.

If so, then the determination becomes “YES” and operations progress to step S1003g to activate the flashlight 7 to emit light, and otherwise the determination becomes “NO” and step S1003g is skipped. In any event, thereafter, at step S1003h, the subject is digitally photographed.

Subsequently, at step S1006, 3-D shape detection processing is performed as will be described later on, thereby detecting the 3-D shape of the subject.

Thereafter, at step S1007, the 3-D shape detection result obtained by the implementation of the 3-D shape detection processing is stored in the external memory 27, and then, at step S1008, the 3-D shape detection result is displayed on the monitoring LCD 10 as a 3-D computer-graphics image.

In this regard, the term “3-D shape detection result” is used herein to mean a set of vertex coordinates obtained by converting a plurality of space-code edge images extracted from a space-coded image as described later on, into 3-D coordinates.

Thereafter, at step S1009, polygon pictures are defined which pass through measured vertices identified by the 3-D shape detection result, and an image of 3-D shape detection result is stored in the projection image storing area 37k, in the form of a stereoscopic image (a three-dimensional computer-graphics image) made up of the surfaces of the defined polygon pictures.

Subsequently, at step S1019, a projecting operation (i.e., the display-image projection) is performed with is similar with the projecting operation (i.e., the display-image projection) of step S806 depicted in FIG. 8.

Thereafter, at step S1011, a determination is made as to whether or not no change has been found in the status of the mode selection switch 9. If so, then the determination becomes “YES” and operations return to step S1002 and otherwise this stereoscopic image processing terminates.

Space-Encoding

In the 3-D shape detection processing executed at step S1006 of FIG. 10, the 3-D shape of a subject is detected by a space-encoding technique which will be described by referring to PIG. 11.

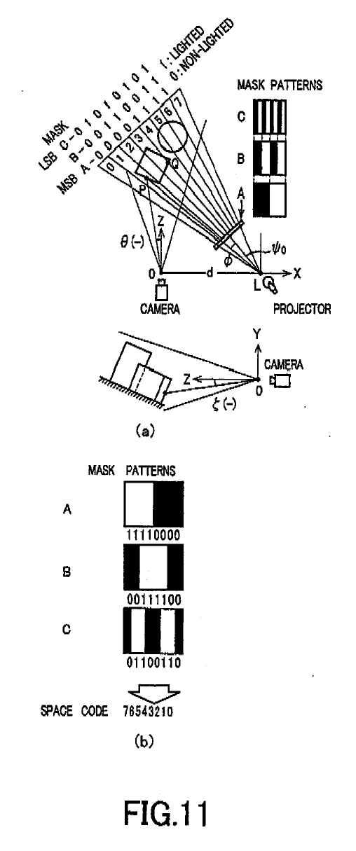

In FIG. 11(a), there are a view showing a real space in which a 3-D coordinate system X-Y-Z is defined, as viewed in a direction of a Y-coordinate axis: a view showing the real space as viewed in a direction of an X-coordinate axis; and a view showing three mask patterns A, B and C each pure-binary-coded.

In contrast, in FIG. 11(b), there are a view showing alternative three mask patterns A, B and C each gray-coded, and a view showing a plurality of space codes.

As shown in FIG. 11(c), the [symbol] techniques of detecting the 3-D shape of a subject by applying the principle of triangulation to between (i) an observed image which is an image of the subject to be observed. (ii) a projection light source (e.g., projector) projecting light (divergent or radiant light) onto the subject, and (iii) an observer (e.g., camera) observing the subject.

In this space-encoding technique, as shown in FIG. 11(a), the projection light source L (“PROJECTOR”) and the observer 0 (“CAMERA”) are disposed a distance d apart from each other. Therefore, an arbitrary point P within an observing space can be identified, provided that both an angle ψ of the projection light and an angle θ at which the observer 0 observes the point P are known.

In this space-encoding technique, further, the observing space is angularly partitioned into a plurality of thin fan- or wedge-shaped subspaces each encoded, for identifying any position on the surface of the subject.

For obtaining from the observed image a code assigned to an arbitrary position on the surface of the subject, a plurality of striped patterns of light are successively projected onto the subject.

A technique of changing light patterns may be of a mechanical type in which different masks are prepared with the same number as that of the different light patterns, and the masks are changed mechanically, or an electronic type in which a linear array of optical striped-shutters each made up of a material having an electro-optical effect are prepared, and the light transmittance of each striped shutter Is controlled electronically.

In the present embodiment, however, the latter electronic type is employed, and more specifically, a plurality of different mask patterns se sequentially reproduced or displayed by the projection LCD 19.

In the example shown in FIG. 11(a), interchangeable masks are disposed between the projection light source L and the subject (a complex of a rectangular solid and a cylinder). In this example, masks A. B and C are prepared to have different patterns, allowing three different light-patterns to be projected onto the subject in succession.

Upon projection of a light pattern generated by each mask A, B, C onto the subject, each of eight fan- or wedge-shaped subspaces (hereinafter, referred to simply as “subspaces”) is encoded either a binary “1” indicative of a bright region, or a binary 0 indicative of a dark region.

Upon successive projection of three light beams passing through the three masks A, B and C, respectively, onto the same subject, each subspace is resultantly assigned a unique code comprised of three bits. These three bits are sequenced from a most significant bit MSB corresponding to the first mask A, to a least significant bit LSB corresponding the last mask C,

Illustratively, in the example shown in FIG. 11(a), one of the subspaces to which the point P belongs is occluded by both the masks A and B, while the one subspace becomes a bright region by only the mask C allowing light to pass therethrough, resulting in the one subspace being eventually encoded “001 (A=0, B=0, C=1).”

Thus, each subspace is assigned a unique code corresponding to the angle 4 which is measured with respect to the geometry of the projection light source L.

On the other hand, by sequentially projecting different light-patterns onto a subject using different mask patterns and by digitally photographing the subject, bright/dark patterns are generated for the subject.

By binarizing these bright/dark patterns on a mask-by-mask basis, bit planes are generated in a data memory. Each bit-plane has consecutive positions (addresses) laterally arrayed, each of which reflects the angle θ measured with respect to the geometry of the observer 0.

Each bit-plane contains the memory values for bits in association with the respective positions (addresses). Each memory-value, which is identifiable in terms of the angle e, is for one bit which describes a corresponding one pixel.

The three masks A, B and C are associated with three bit-planes. By sequentially addressing the memory values contained in the three bit-planes on a pixel-by-pixel basis, a sequence of three bits is identified per pixel, which eventually formulates a corresponding 3-bit code. Each code identifies the angle ψ at which a corresponding subspace is located with respect to the projection light source L.

Provided that the angles ψ and θ of any target point on the surface of the subject are identified, 3-D coordinates of the target point can be identified through triangulation, because of the known distance d.

In the example shown in FIG. 11(a), a global space is pure-binary-encoded using a plurality of masks such as the mask A, B and C. In the example shown in FIG. 11(b), in contrast, the global space is encoded using space-codes in the form of gray codes in which a Hamming distance between adjacent codes is always fixed to “1,” using a plurality of masks such as the mask A, B and C.

In the present embodiment, for performing the aforementioned 3-D shape detection processing, the space-encoding technique may be implemented using any one of the pure binary code scheme and the gray code scheme.

This space-encoding technique is disclosed in more detail in, for example, “Range Picture Input System Based on Space-Encoding,” the Institute of Eleotronics, Information and Communication Engineers, Kosuke Sato and Seiji Inokuchi, Japan: 1985/3 Vol. J68-D No. 3, pp. 369 to 375, the content of which is incorporated therein by reference.

3-D Shape Detection Processing

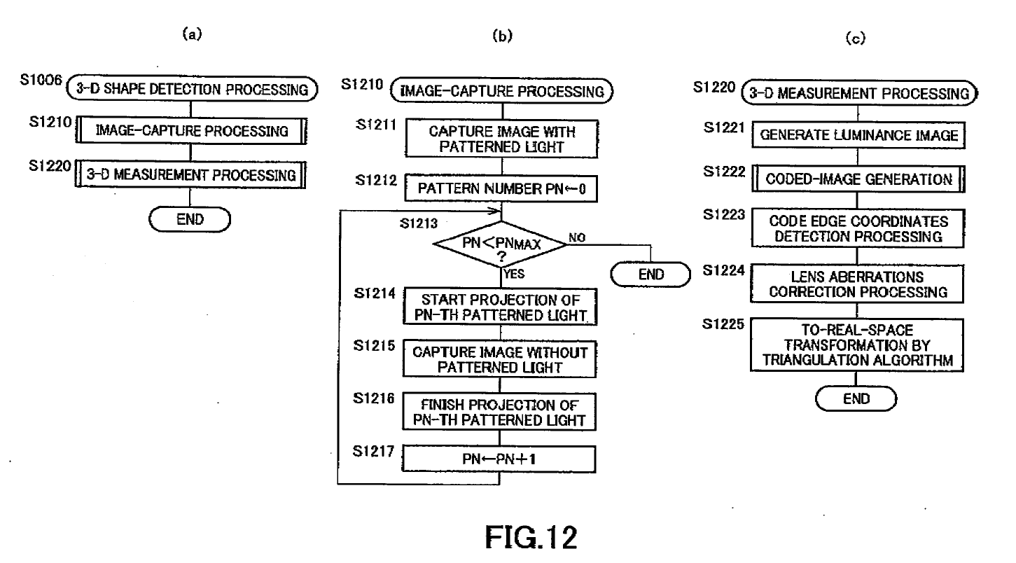

Referring next to FIG. 12(a), step S1006 in FIG. 10 is conceptually shown in flow chart at a 3-D shape detection processing routine.

This 3-D shape detection processing routine starts with step S1210 to perform the image-capture processing.

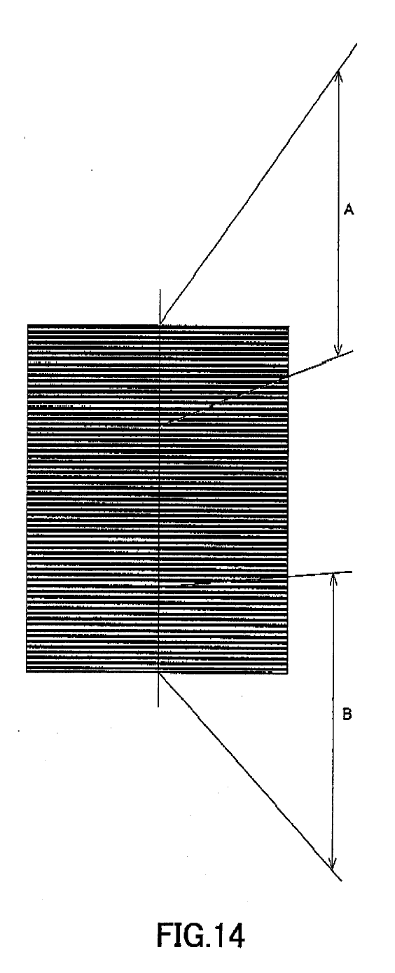

Upon initiation of this image-capture processing, different striped-light-patterns (see FIGS. 1 and 14, for example) are sequentially projected onto a subject from the projecting section 13, using, for example, the different gray-coded mask patterns in FIG. 11(b). Further, different patterned-light-illuminated images are captured by digitally photographing the subject with the different light patterns being projected thereonto, respectively, and one patterned-light-non-illuminated image is captured by digitally photographing the same subject with no light pattern being projected thereonto. Upon termination of this image-capture processing, at step S1220, 3-D measurement processing is performed.

Upon initiation of this 3-D measurement processing, the patterned-light-illuminated images and the one patterned-light-non-illuminated image each captured by the preceding image-capture processing are utilized to substantially measure the 3-D shape of the subject. Upon termination of this 3-D measurement processing, this 3-D shape detection processing terminates.

Image-Capture Processing

Referring next to FIG. 12(b), step S1210 in FIG. 12(a) is shown conceptually in flow chart as an image-capture processing subroutine.

This :mage-capture processing subroutine starts with step S1211 to execute the patterned-light photographing program 36a for capturing the one patterned-light-non-illuminated image by causing the image-capturing section 14 to photograph the subject without causing the projecting section 13 to project any light pattern onto the subject. The captured patterned-light-non-illuminated image is stored in the patterned-light-non-illuminated image storing area 37b.

Next, at step S1212, a zero initialization is made of a pattern number PN indicative of one of serial numbers of the mask patterns for use in structuring corresponding respective light patterns.

Subsequently, at step S1213, a determination is made as to whether or not a current value of the pattern number PN is smaller than a maximum value PNmax. The maximum value PNmax is pre-determined so as to reflect the total number of the mask patterns to be projected. For example, the maximum value PNmax is set to eight, when eight light patterns are to be used in total.

If the current value of pattern number PN is smaller than the maximum value PNmax, then the determination of step S1213 becomes “YES” and operations progress to step S1214 to display on the projection LCD 19 one of the mask patterns to be used, which has been assigned a mask serial No. equal to the current value of the pattern number PN. The one mask pattern is a PN-th mask pattern.

At step S1214, by its further implementation, a PN-th light pattern which is formed by the PN-th mask pattern is projected onto the subject, and then, at step S1215, the image-capturing section 14 is activated to photograph the subject with the PN-th light pattern been projected thereonto.

This photographing operation results in the capture of a PN-th patterned-light-illuminated image which represents the subject onto which the PN-th light pattern has been projected. The captured patterned-light-illuminated image is stored in the patterned-light-illuminated image storing area 37a in association with the corresponding value of the pattern number PN.

Upon termination of this photographing operation, at step S1216, the projection of the PN-th light pattern terminates, and then, at step S1217, the pattern number PN is incremented one in preparation for the projection of the next light pattern. Then, operations return to step S1213.

If the current value of the pattern number PN, as a result of the repetition of steps S1213-S1217 a number of times equal to the total number of the light patterns, becomes not smaller than the maximum value PNmax, then the determination of step S1213 becomes KNOW and this image-capture processing terminates.

As will be evident from the above, one cycle of implementation of the image-capture processing allows the acquisition of both the one patterned-light-non-illuminated image and a number of patterned-light-illuminated images which is equal to the maximum value PNmax.

3-D Measurement Processing

Referring next to FIG. 12(c), step S1220 in FIG. 12(a) is shown conceptually in flow chart as a 3-D measurement processing subroutine.

This 3-D measurement processing subroutine starts with step S1221 to generate luminance images by the execution of the luminance image generation program 36c.

At step S1221, a luminance value, which is defined as a Y value in a YCbCr color space, is calculated from R, G and B values of individual pixels, based on the following exemplary formula:
Y=0.2989×R+0.5866×G+0.1145×B.

The calculation of the Y value per pixel enables the generation of a plurality of luminance images which relate to the patterned-light-illuminated images and the one patterned-light-non-illuminated image, respectively. The generated plurality of luminance images are stored in the luminance image storing area 37c in association with the corresponding respective pattern numbers PN.

The formula employed to calculate the luminance images or values is not limited to the above formula, but may be alternative formulas, where appropriate.

Next, at step S1222, the coded-image generation program 36d is executed. Upon initiation of this program 36d, the generated luminance images are combined using the aforementioned space-encoding technique, thereby generating a coded image having pixels to which space codes are assigned pixel-by-pixel.

The coded image is generated through a binarizing operation in which a comparison is made between the luminance images for the patterned-light-illuminated image which have been stored in the luminance image storing area 37c, and a threshold image having pixels to which light-intensity thresholds or luminance thresholds are assigned pixel-by-pixel. The generated coded image is stored in the coded-image storing area 37d.

Local Adaptive Filtering and Thresholding

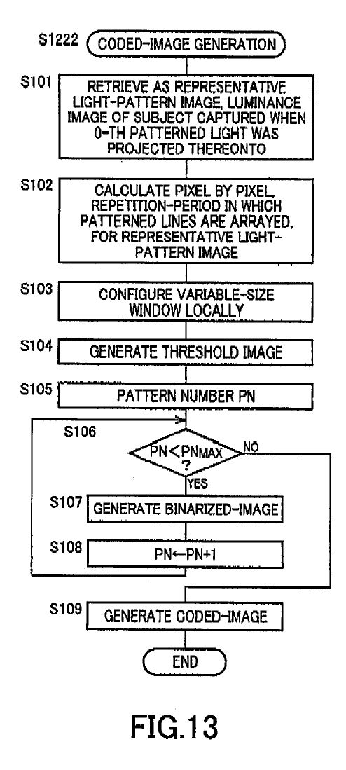

Referring next to FIG. 13, the detail of this coded-image generation program 36d it shown conceptually in flow chart. This program 36d will be described step-by-step below by referring to FIG. 13, the underlying principle of which will be described beforehand by referring to FIGS. 14-21.

In the present embodiment, a plurality of luminance images are generated for the same subject (i.e., a three-dimensional object) under the effect of a plurality of projected different light patterns, respectively. The different light patterns are each structured so as to have bright portions (i.e., bright patterned lines each having a width) and dark portions (i.e., dark patterned lines each having a width) which alternate In a uniform patterned-lines repetition-period or at equal intervals.

The different light patterns, each of which is referred to as a light pattern having a pattern number PN, are different from each other in terms of a repetition period of the patterned lines in each light pattern. One of the light patterns which has the shortest patterned-lines repetition-period among them is a light pattern having a pattern number PN of no,n while one of the light patterns which has the longest patterned-lines repetition-period among them is a light pattern having a pattern number PN of “PNmax−1.”

Each and every luminance image, because of its acquisition with the projection of a corresponding light pattern, is formed as a light-pattern image in which bright patterned lines as bright portions and dark patterned lines as dark portions alternate in a linear array.

The distances or spacings between adjacent patterned lines, because of their dependency upon the relative geometry (the relations on position and orientation) between the image input/output device 1 and a subject to be imaged, are not always uniform throughout each luminance image.

In addition, different luminance images acquired with the effect of the respective projected different-light-patterns are identified by the pattern numbers PN of the corresponding respective light patterns.

In the present embodiment, one of the different luminance images is selected as a representative light-pattern image, The typical example of such a representative light-pattern image is a luminance image corresponding to one of the different light patterns which has the shortest patterned-lines repetition-period among them, that is to say, a luminance image having a pattern number PN of “0.”

In FIG. 14, the luminance image having a pattern number PN of “0” is shown as an exemplary version of the representative light-pattern image.

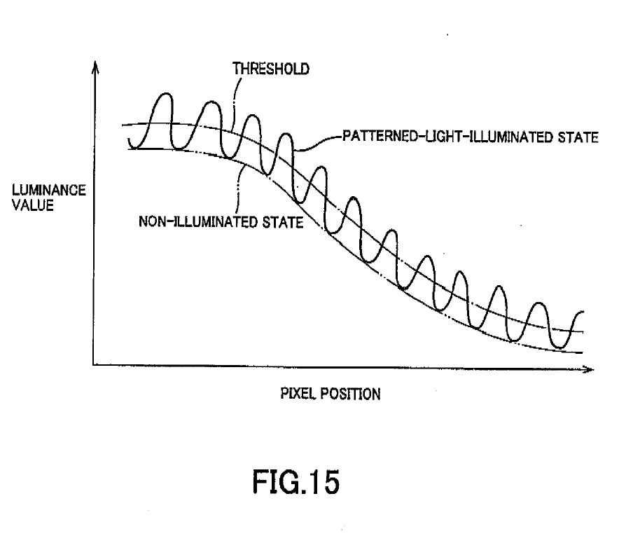

In FIG. 15, there is graphed in solid line a luminance value which changes periodically and spatially as a function of a pixel position along a linear array of pixels, and which occurs in an exemplary luminance image acquired by digitally photographing a subject onto which a light pattern has been projected. There is emphasis on the solid line graph for illustrative purposes.

In FIG. 15, there is further graphed in two-dotted line an envelope curve tangent to the solid line graph at its lower peak points (i.e., minimum luminance points).

This envelope curve indicates spatial change in the luminance value of a luminance image acquired by digitally photographing the same subject without illumination, that is to say, spatial change in the luminance value of the background light of the subject.

For a pixel-by-pixel luminance-value of a luminance image featured by such an envelope curve to be accurately binarized through thresholding, a threshold used therein is preferably caused to vary as a function of a pixel position. That is to say, the threshold is preferably caused to adaptively vary to follow an actual change in the luminance value in a luminance image through tracking.

Based on the above findings, in the present embodiment, a filtering-window is locally applied to a target luminance-image for local filtering or windowing of the target luminance-image for local-threshold calculation, and the filtering or windowing process allows local thresholds to be properly set for successive local sub-areas of the target luminance-image.

More specifically, once a window is applied to a particular one of the sub-areas of a target luminance-image, selection is made of ones of a plurality of patterned lines collectively making up the target luminance-image, which ones are found through the window, and selection is made of ones of all pixels collectively forming the selected patterned lines, which ones are present within the window. The luminance values of the selected pixels are extracted from the target luminance-image for determining a local threshold in association with the particular local position on the target luminance-image,

The window used in the present embodiment is in the form of a rectangular window. When using this rectangular window, patterned lines are selected which are found through the rectangular window, pixels are selected which are present within the rectangular window, and the luminance values of the selected pixels are extracted from the target luminance-image. Common weighting-factor(s) is applied to the extracted pixels for threshold calculation. The weighting factor(s) defines a window function of the rectangular window.

Additionally, when using this rectangular window which has a line-direction-size measured in a line direction in which each of arrayed patterned-lines of a target luminance-image elongates, and a array-direction-size measured in an array direction in which the patterned lines are arrayed, the number of pixels present within the rectangular window can vary as a function of the line-direction-size of the rectangular window, and the number of laterally-arrayed patterned lines and the number of pixels both present within the rectangular window can vary as a function of the array-direction-size of the rectangular window.

As a result, when using the rectangular window, a local threshold calculated from a target luminance-image by locally applying the rectangular window thereto can vary as a function of the array-direction-size of the rectangular window. Therefore, adaptive change in the value of local threshold, if required, can be adequately achieved by adaptive change in the array-direction-size of rectangular window.

The window used in the present embodiment, however, may be alternatively a non-rectangular window such as a Hanning window, a Hamming window, etc.

When using this non-rectangular window, at least one variable coefficient or factor (e.g., a matrix consisting of variable filter coefficients) in a window function defining the non-rectangular window can make differences in characteristic between individual local thresholds calculated from a target luminance-image through filtering using the non-rectangular window previously determined.

When using the non-rectangular window, for example, adaptive change in value of the at least one variable coefficient or factor can make differences in characteristic between individual local thresholds calculated from a target luminance-image through filtering using the non-rectangular window defined, even with both the line-direction-size and the array-direction-size of the non-rectangular window being fixed.

In the present embodiment, the size of the window formed as a rectangular window is preferably set so as to be equal to any one of the integer multiples of the spacing or period of the patterned lines (e.g., the period in which bright patterned lines repeat) within the window. In other words, the window size is preferably set to allow bright patterned lines and dark patterned lines to be present in the window in equal numbers. The thus-setting of the window-size, as a result of the calculation of the average of luminance values of patterned lines within the window, allows the accurate determination of proper thresholds.

A possibility, however, exists that the repetition period of patterned lines can vary with location, even on the same luminance image. For this reason, a fixed-size window can cause the number of patterned lines within the window, to vary with location, resulting in degraded thresholds in accuracy.

In FIG. 14, for an exemplary luminance-image which is made up of a plurality of patterned lines arrayed in the array direction, two regions arrayed in the array direction are denoted by symbols “A” and “B,” respectively.

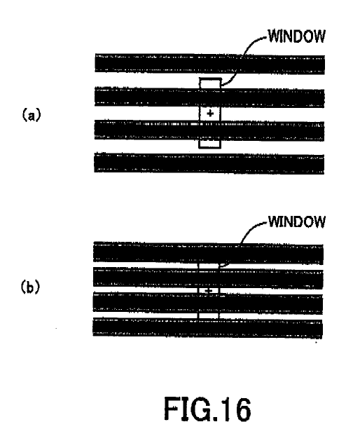

In FIG. 16(a), a selected part of patterned lines which are located within the region A depicted in FIG. 14 is shown in enlargement. In the region A, patterned lines equal in color are arrayed in a certain length of period.

In contrast, in FIG. 16(b), a selected part of patterned lines which are located within the region B depicted In FIG. 14 is shown in enlargement. In the region B, patterned lines equal In color are arrayed in a repetition period different from a regular repetition-period, that is to say, shorter than the certain repetition-period depicted in FIG. 16(a).

In FIGS. 16(a) and 16(b), a fixed-size window is shown as a comparative example by being visualized for illustrative purposes, wherein the fixed-size window is provided for the luminance image depicted in FIG. 14.

In the region A which is shown in FIG. 16(a) in partial enlargement, the number of equally-colored patterned-lines present within the fixed-size window is almost exactly two. In contrast, in the region B which is shown in FIG. 16(b) in partial enlargement, the number of equally-colored patterned-lines present within the fixed-size window is greater than two and less than three.

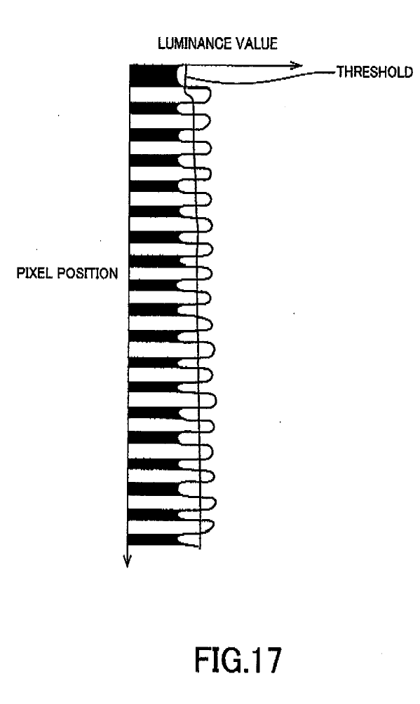

For the above reasons, for the region A depicted in FIG. 16(a). thresholds, which have been calculated as the averages of the luminance values of pixels captured by the fixed-size window at respective successive positions, are stable in level as going in the array direction of the luminance image, as shown in FIG. 17 in graph.

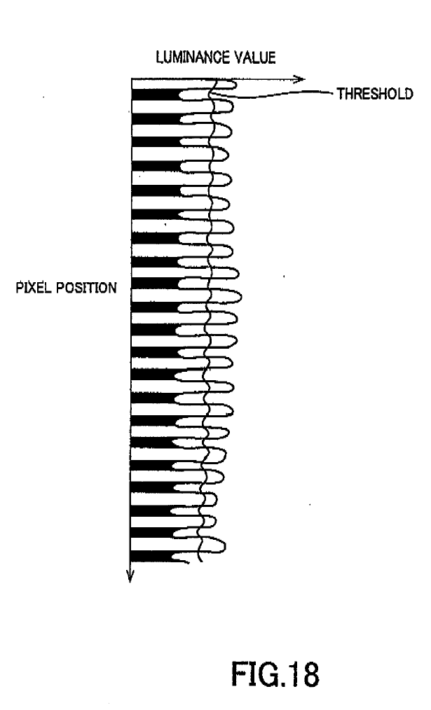

In contrast, for the region B depicted in FIG. 16(b), thresholds, which have been calculated as the averages of the luminance values of pixels captured by the fixed-size window at respective successive positions, oscillate in level as going in the array direction of the luminance image, as shown in FIG. 18 in graph.

Thresholds are desirably calculated for a luminance image so as to be in conformity with the contour of an envelope curve of a luminance-value curve for the dark or bright portions in the luminance image. Oscillation of calculated thresholds would typically mean the presence of errors in the calculated thresholds. Such undesired thresholds, if used for binarizing the luminance image, would make it more difficult to improve the accuracy in binarizing the luminance image.

In the present embodiment, one of a plurality of luminance images is selected as a representative light-pattern image, which was obtained with the effect of projection of a light pattern of lines arrayed in the shortest repetition period among those of all light patterns. That is to say, the representative light-pattern image is a luminance image assigned a pattern number PN of “0.”

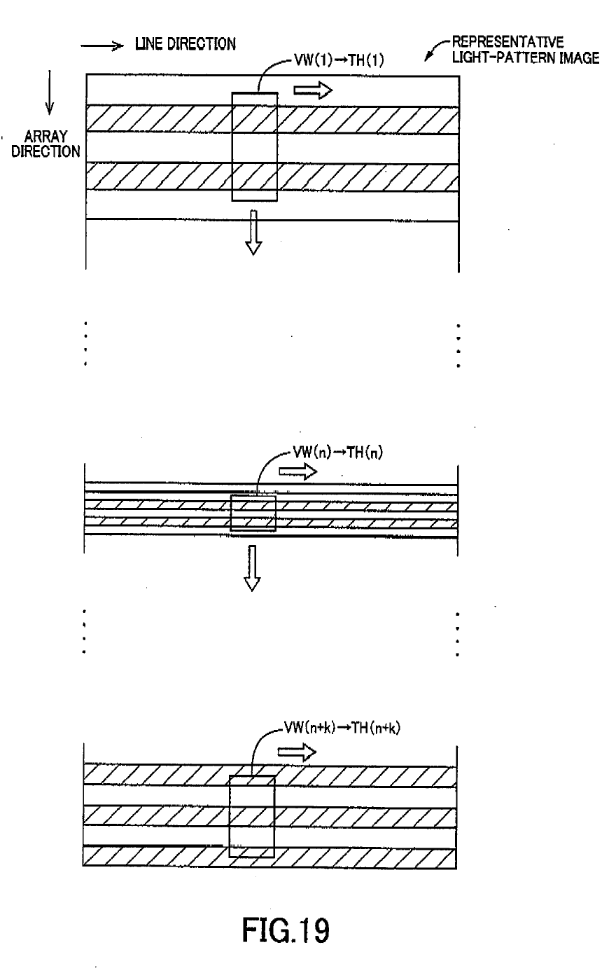

Further, in the present embodiment, as shown in FIG. 19, a window which is locally applied to the representative light-pattern image, is in the form of a variable-size window VW. Owing to this, the variable-size window VW is caused to adaptively change in size in response to the repetition period of actual patterned lines in the representative light-pattern image.

In the present embodiment, therefore, as shown in FIG. 19, even though the repetition period of patterned lines in the representative light-pattern image changes as a function of the position in the array direction of the representative light-pattern image, the size of the variable-size window VW changes so as to follow the change in the repetition period, with the result that the total number of bright and dark patterned-lines within the variable-size window VW remains constant, irrespective of changes in the repetition period of patterned lines.

In the present embodiment, a threshold TH Is determined each time the variable-size window VW is locally applied to the representative light-pattern image on a local-position-by-local-position basis. The local-position-by-local-position threshold TH is accurately obtained based on the variable-size window VW optimized in size on a local-position-by-local-position basis.

In addition, the variable-size window VW, which allows the total number of bright and dark patterned-lines within the variable-size window VW to remain constant, is minimized in size when those patterned-lines appear on a luminance image having a pattern number PN of “0.” For this reason, the selection of the luminance image having a pattern number PN of “0” as the representative light-pattern image allows the variable-size window VW to be minimized in size, and eventually allows a reduction in computational load for filtering after using the variable-size window VW.

In the present embodiment, the variable-size window VW is in the form of a rectangular-window having a variable size. More specifically, this variable-size window VW is configured so as to be variable in size in the array direction of the representative light-pattern image, and so as to be fixed in the line direction of the representative light-pattern image.

Patterned-Lines Repetition-Period Determination

In the present embodiment, the size of the variable-size window VW, that is to say, the extent of the variable-size window VW measured in the array direction of the representative light-pattern image, is adaptively set so as to reflect the spacings between the real patterned lines of the representative light-pattern image. This adaptive setting of the size of the variable-size window VW requires prior knowledge of the distribution of the spacings between the real patterned lines of the representative light-pattern image.

For these reasons, in the present embodiment prior to the adaptive setting of the size of the variable-size window VW, a fixed-size window is locally applied to the representative light-pattern image. A plurality of adjacent pixels captured at a time by application of the fixed-size window are selected as a plurality of target pixels, and based on the luminance values of the selected target pixels, the patterned-lines spacing distribution of the representative light-pattern image is determined.

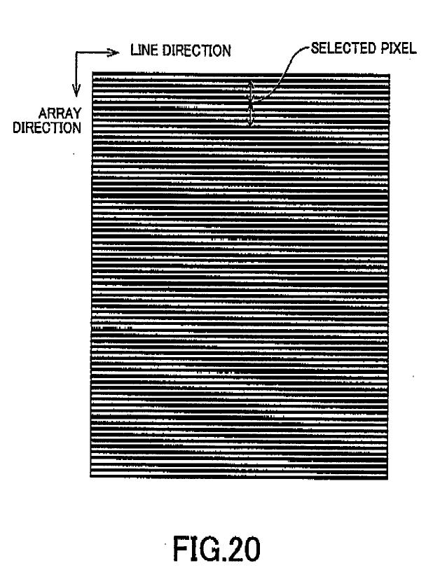

Referring next to FIG. 20, an illustrative example of the representative light-pattern image is shown for explanation of how the fixed-size window is applied to the representative light-pattern image for determining the patterned-lines spacing distribution of the representative light-pattern image.

In this representative light-pattern image, a plurality of pixels are in a two-dimensional array extending in both the line direction and the array direction of this representative light-pattern image.

In this representative light-pattern image, one of a plurality of pixels arrayed in the array direction is successively selected, and the fixed-size window is locally applied to this representative light-pattern on a selected-pixel-by-selected-pixel basis.

The fixed-size window, which is configured to have a size large enough to capture 256 pixels at a time, is locally applied to the representative light-pattern image so as to cover an elongated region in which a currently-selected pixel is located centrally of the region and preceding and subsequent pixels to the currently-selected pixel are included.

In the example shown in FIG. 20, the fired-size window provided at a given time is symbolized by a linear array of two arrowed-lines which are located above and below the currently-selected pixel, respectively, for illustrative purposes.

In the present embodiment, additionally, Fast Fourier Transform (FFT) is performed on the luminance values of a plurality of target pixels in the representative light-pattern image, thereby measuring intensities (e.g., a power spectrum) of frequency components of a series of luminance values found in the representative light-pattern image, resulting from variations in the luminance value in the array direction of the representative light-pattern image.

In this regard, the frequency of each of the “frequency components” is defined to mean a repetition number in which uniform luminance values repeat in a linear array of the target-pixels captured at a time by the fixed-size window at a given time, wherein the target pixels are sequenced in the array direction of the representative light-pattern Image.

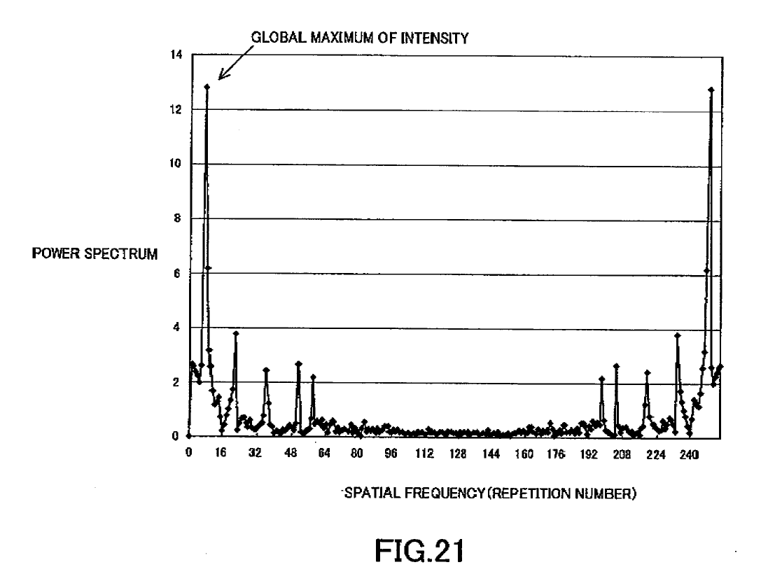

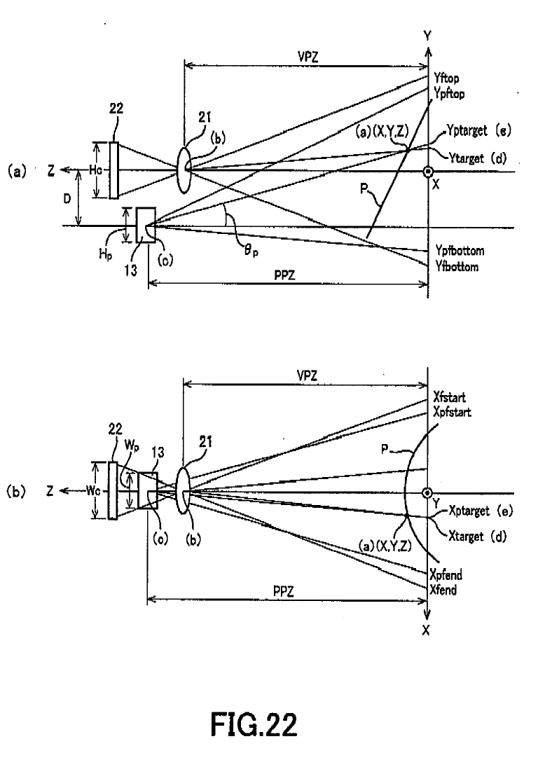

In FIG. 21, the result of an exemplary frequency analysis by the FFT processing is shown in a graph having a horizontal axis and a vertical axis. In FIG. 21, the frequency (i.e., the repetition number) is taken on the horizontal axis, while the level of a power spectrum is taken on the vertical axis.

The graph of FIG. 21 indicates the presence of a plurality of spatial frequencies having local maxima of intensity in the power spectrum. Data indicative of the characteristic expressed by the power spectrum is an example of the “spatial frequency characteristic data” set forth in the above mode (1).

The exemplary result shown in FIG. 21 indicates that, for a current region having 256 consecutive pixels, uniform luminance values repeat seven times with a maximum frequency of occurrence. This indicates that equally-colored patterned-lines repeat in a patterned-lines repetition-period having a length worth 256/7 pixels or about 37 pixels, with a maximum frequency of occurrence.

Therefore, the size (i.e., the array-direction-size) of the aforementioned variable-size window VW is preferably set to a length worth about 37 pixels which is commensurate with the patterned-lines repetition-period, a length worth about 73 pixels which is commensurate with twice the patterned-line repetition-period, or a length equal to an alternative integer multiple of the patterned-lines repetition-period.

It is added that, although, in the present embodiment, the Fourier transform is performed for determining the patterned-lines repetition-period of the representative light-pattern image, alternative approaches may be employed for achieving the same goal.

In an example, a predetermined number of adjacent pixels are targeted on a selected-pixel-by-selected-pixel basis. The adjacent pixels include neighboring pixels to a successively-selected one of a plurality of pixels collectively making up the representative light-pattern image, in the array direction. The neighboring pixels include pixels located before and after the successively-selected pixel, as viewed in the array direction.

In this example, the period in which local maxima of luminance repeat in the targeted adjacent pixels is determined in pixels, and the patterned-lines repetition-period can be detected based on the determined period.

It is further added that, in the present embodiment, successive selection is made of one of a plurality of adjacent pixels consecutively sequenced in the array direction of the representative light-pattern image, and the patterned-lines repetition-period is determined based on the distribution of luminance values of the representative light-pattern image on a selected-pixel-by-selected-pixel basis.

In an alternative approach for determining the patterned-line period, a sub-plurality of isolated spaced apart at every at least one pixel are selected from a plurality of adjacent pixels arrayed in the array direction in the representative light-pattern image.

In this alternative approach, successive selection is made of one of the sub-plurality of non-adjacent pixels, and the patterned-lines repetition-period is determined based on the distribution of luminance values of the representative light-pattern image on a selected-pixel-by-selected-pixel basis.

In this alternative approach, for each of non-selected pixels in the plurality of adjacent pixels, the patterned-lines repetition-period is determined by considering a pre-calculated value of the patterned-lines period for one of selected pixels which is located adjacent to each non-selected pixel, by specified algorithm such as interpolation.

This alternative approach would allow the patterned-lines repetition-period to be determined without performing complex calculation for each and every one of the plurality of adjacent pixels.

In addition, when using a window having at least one variable parameter for local adaptive thresholding of the representative light-pattern image, the window parameter is configurable using as a cut-off period of the window, a patterned-lines repetition-period based on the calculated distribution of spacings between the patterned-lines. For configuration of the window parameter based on the cut-off period, a well-known conventional digital low pass filter design may be employed.

Coded-Image Generation

This coded-image generation program 36d, although has been described above in terms of its basic idea by referring to FIGS. 14-21, will be described below step-by-step by referring to FIG. 13.

This coded-image generation program 364 starts with at step 5101 to retrieve from the luminance image storing area 37c, the luminance image of a subject which was captured with the light pattern whose pattern number PN is “0” being projected onto the subject, as the representative light-pattern image

Next, at step S102, a pixel-by-pixel calculation is made of a patterned-lines repetition-period in association with each of adjacent pixels consecutively sequenced within the representative light-pattern image in the array direction thereof, based on the retrieved luminance image, by an approach of the aforementioned FFT conversion.

A plurality of ultimate calculations of patterned-lines-repetition-periods are stored in the period distribution storing area 37p, in association with the respective pixels (i.e., respective pixel-positions in the array direction).

Subsequently, at step S103, the characteristic of the aforementioned variable-size window VW is locally configured in succession in the array direction, based on the plurality of ultimate calculations of patterned-lines-repetition-periods. In other words, a plurality of sets of characteristic data of the variable-size window VW are generated locally and sequentially for the representative light-pattern image.

In the present embodiment, the variable-size window VW is configured such that its line-direction-size is kept unchanged irrespective of the position of a moving local-region on the representative light-pattern image to which the variable-size window VW is locally applied, while the array-direction-size is variable to be kept equal to an integer multiple of a variable value of a successively-selected one of the patterned-lines repetition-periods calculated in association with the respective positions arrayed in the array direction of the representative light-pattern image.

Thereafter, at step S104, the variable-size window VW is locally applied to the representative light-pattern image In a two-dimensional sliding manner, in association with a sequentially-selected one of a plurality of pixels arrayed two-dimensionally on the representative light-pattern image.

In the two-dimensional sliding manner, the variable-size window VW first moves sequentially in the line direction, at one pixel position as viewed in the array direction, while making a pixel-by-pixel calculation of the luminance-value average of pixels present within the variable-size window VW at each point of time, as a local threshold.

Upon termination of one movement in the line direction, the variable-size window VW shifts to the next pixel position in the array direction for another movement in the line direction for calculation of successive local thresholds.

At step S104, by its further implementation, a threshold image is generated by allocating the thus-calculated local thresholds to the corresponding respective pixels of the representative light-pattern image. The generated threshold image is stored an the threshold image storing area 37q.

Subsequently, at step S105, the pattern number PN is initialized to “0,” and then, at step 5106, a determination is made as to whether or not a current value of the pattern number PN is smaller than the maximum value PNmax. In this instance, the current value of the pattern number PN is “0,” and therefore, the determination becomes “YES” and operations progress to step S107.

At step S107, a pixel-by-pixel comparison is made between the luminance values of the luminance image whose assigned pattern number PN is equal to the current value of the pattern number PN, and the local thresholds of the generated threshold image. A binarized image is formed pixel-by-pixel so as to reflect the result of the pixel-by-pixel comparison.

More specifically, for a pixel position at which the current luminance image has its luminance value greater than the corresponding local threshold, data indicative of a binary “1” is assigned to the corresponding binarized image at its corresponding pixel position and is stored in the binarized image storing area 37r in association with the corresponding pixel position of the corresponding binarized image.

On the other hand, for a pixel position at which the current luminance image has its luminance value not greater than the corresponding local threshold, data indicative of a binary “0” is assigned to the corresponding binarized image at its corresponding pixel position and is stored in the binarized image storing area 37r in association with the corresponding pixel position of the corresponding binarized image.

Thereafter, at step S108, the pattern number PN is incremented one and then operations return to step S106 to make a determination as to whether or not a current value of the pattern number PN is smaller than the maximum value PNmax. If so, then the determination becomes “YES” and operations progress to step S107.

If the current value of pattern number PN, as a result of the repetition of steps S106-S108 a number of times equal to the total number of the light patterns, becomes not smaller than the maximum value PNmax, then the determination of step S106 becomes “NO” and operations progress step S109.

At step S109, pixel-by-pixel pixel extraction is performed of pixel values (either a binary “1” or “0”) from a set of binarized images whose number Is equal to the maximum value PNmax, in the sequence from a binarized image corresponding to a luminance image whose pattern number PN is “0” to a binarized image corresponding to a luminance image whose pattern number PN is “PNmax−1,” resulting in the generation of a space code made up of bits arrayed from a least significant bit LSB to a most significant bit MSB.

The number of bits collectively making up a pixel-by-pixel space-code is equal to the maximum value PNmax. The pixel-by-pixel generation of space codes results in the generation of a space coded image corresponding to a current subject. The generated space codes are stored in the coded-image storing area 37d.

Then, one cycle of execution of this coded-image generation program 36d terminates.

Code Edge Coordinates Detection

Upon termination of the coded-image generation program 36d, at step 51223 in FIG. 12(c), code-edge-coordinates detection processing is performed by the execution of the code edge extraction program 36e.

In the present embodiment, encoding is carried out using the aforementioned space-encoding technique on a per-pixel basis, resulting in the occurrence of a difference on a sub-pixel order between an edge or border line separating adjacent bright and dark portions in an actual light-pattern, and an edge or border line separating adjacent different space-codes in the generated coded-image. In the coded image, the edge or border line separates a region assigned a space code and another region assigned another space code.

In view of the above, the code-edge-coordinates detection processing is performed for the purpose of detecting code edge coordinates of space codes with sub-pixel accuracy.

The detected code edge coordinates are stored in the code edge coordinates storing area 37e. The code edge coordinates are defined in a CCD coordinate-system ccdx-ccdy which is a two-dimensional coordinate system fixed with respect to the image plane of the CCD 22.

Lens Aberrations Correction Processing

Following step S1223, at step S1224, lens aberrations correction processing is performed by the execution of the lens aberrations correction program 36f.

A light beam, after passing through the image-capture optical system 21, is focused at an actual position deviated from an ideal position due to aberrations or distortion in the image-capture optical system 21, if any. If the image-capture optical system 21 is of optically ideal lens, the light beam is focused at the ideal position.

In view of this, the lens aberrations correction processing is performed for correcting the actual position such that it becomes closer to the ideal position.

Owing to this lens aberrations correction processing, the code edge coordinates detected at step S1223 are corrected so as to eliminate errors due to such as distortion in the image-capture optical system 21. The thus-corrected code-edge-coordinates are stored in the aberration correction coordinates storing area 37g.

None of the above-described code-edge-coordinates detection processing and lens aberrations correction processing is essential in understanding the present invention, and both of them are disclosed in more detail in Japanese Patent Application Publication No. JP2005-293075. The further detailed description of the code-edge-coordinates detection processing and the lens aberrations correction processing, therefore, will be omitted herein, while the publication is incorporated herein by reference.

Triangulation

Following step S1224, at step S1225, real-space conversion processing is performed through triangulation by the execution of the triangulation calculation program 36g.

Once this real-space conversion processing starts, the aforementioned aberrations-corrected the code edge coordinates in the CCD coordinate system ccdx-ccdy is converted through triangulation into 3-D coordinates defined in a real space coordinate system X-Y-Z fixed with respect to a real space, resulting in the acquisition 3-D coordinates representative of a 3-D shape detection result. The acquired 3-D coordinates are stored in the 3-D coordinates storing area 37h.

Then, the algorithm will be described below for converting 2-D coordinates defined in the CCD coordinate system ccdx-ccdy into 3-D coordinates in the real space coordinate system X-Y-Z, through triangulation, in more detail by referring to FIG. 22.

In the present embodiment, as shown in FIG. 1, the laterally-curved document P as a to-be-imaged object is digitally photographed in the real space coordinate system X-Y-Z which is fixed with respect to the image input/output device 1. As shown in FIG. 22, the real space coordinate system X-Y-Z is located with respect to the image input/output device 1 so as to have its X-axis extending horizontally, its Y-axis extending vertically, and its Z-axis extending in the direction of an optical axis of the image-capture optical system 21.

The real space coordinate system X-Y-Z is shown as viewed in the X-axis direction in FIG. 22(a), and is shown as viewed in the Y-axis direction in FIG. 22(b). This real space coordinate system K-Y-Z is located with respect to the image input/output device 1 so as to have its origin spaced a distance VPZ apart from the position of an input pupil of the image-capture optical system 21, in the direction of the Z-axis.

Representations of Symbols

θp and D

In this real space coordinate system X-Y-Z, symbol “θp” denotes a projection angle at which the projecting section 13 projects a light ray onto the document P at an arbitrary point of target, and symbol “D” denotes a distance between an optical axis of the image-capture optical system 21 and an optical axis of the projecting section 13. The projection angle θp is uniquely identified by specifying one of space codes pixel-by-pixel assigned to a captured image.

Xtarget and Ytarget

Further, in this real space coordinate system X-Y-Z, symbols “Xtarget” and “Ytarget” denote X coordinates and Y coordinates of a point of intersection between a straight line obtained by extending back an optical path along which reflected light from a point of target on the document P enters the CCD 22, and an X-Y plane of this real space coordinate system X-Y-Z, respectively.

Xfstart, Xfend, Yftop and Yfbottom

Still further, in this real space coordinate system X-Y-Z, a field of view of the image-capture optical system 21 as viewed in the Y-axis direction is defined as a region extending from a point denoted by “Yftop” to a point denoted by “Yfbottom,” while a field of view of the image-capture optical system 21 as viewed in the X-axis direction is defined as a region extending from a point denoted by “Xfstart” to a point denoted by “Xfend.”

Hc and Wc

Yet further, in this real space coordinate system X-Y-Z, symbol “He” denotes a length (or height) of the CCD 22 as viewed in the Y-axis direction, while symbol “Wc” denotes a length (or width) of the CCD 22 as viewed in the X-axis direction.

When using the thus-defined real space coordinate system X-Y-Z, there are derived 3-D coordinates (X, Y, Z) in the real space coordinate system corresponding to coordinates (c ds, ccdy) of an arbitrary point in the CCD coordinate system coordinate system ccdx-ccdy of the CCD 22, by solving five equations (described later on) relating to the relationship pertaining to the following factors:

(a) A point of target (X, Y, 2) on the document P (indicated by symbol “(a)” with a leader line, in FIG. 22);

(b) The position of the input pupil of the image-capture optical system 21(indicated by symbol “(b)” with a leader line, in FIG. 22);

(c) The position of the output pupil of the projection optical system 20 (indicated by symbol “(c)” with a leader line, in FIG. 22);

(d) The point of intersection (Xtarget, Ytarget) between a straight line passing through the input pupil of the image-capture optical system 21 and the point of target on the document P, and the X-Y plane (indicated by symbol “(d)” with a leader line, in FIG. 22); and

(e) A point of intersection between a straight line passing through the output pupil of the projection optical system 20 and the point of target on the document P , and the X-Y plane (indicated by symbol “(e)” with a leader line, in FIG. 22).

The above-mentioned five equations are as follows:
Y=(PPZ−Z)×tan θp−D+cmp(Xtarget) (1)
Y=−(Ytarget/VPZ)Z+Ytarget (2)
X=−(Xtarget/VPz)Z+Xtarget (3)
Ytarget=Yftop−(ccdcy/Hc)×(Yftop−Yfbottom) (4)
Xtarget Xfstart+(ccdcx/Wc)×(Xfend−Xfstart) (5)

The “cmp(Xtarget)” in equation (1) denotes a function of correcting for deviation between the image-capture optical system 20 and the projecting section 13, which can be deemed as a value of “0” in an ideal condition in which there is no deviation.

Further, in this real space conversion processing, coordinates (ccdx, ccdy) of an arbitrary point in a real image is converted into coordinates (ccdcx, ccdcy) in an image captured by an ideal camera.

The conversion is performed using the following three equations which are approximated equations for camera calibration:
ccdcx=(ccdx−Centx)/(1+dist/100)+Centx (6)
ccdcy=(ccdy−Centy)/(1+dist/100)+Centy (7)
hfa=arctan[(((ccdx−Centx)²+(ccdy−Centy)²)^{0.5})×pixellength/focallength] (8)

It is noted that the “dist” denotes a distortion (or aberrations) [%], which is described, using a function f of a half view-of-anglehfa[deg], as dist=f (hfa). The “focallength” denotes a focal length [mm] of the image-capture optical system 21. The pixellength denotes a CCD pixellength [mm]. The coordinates of the position of the lens center in the CCD 22 are defined as “(Centx, Centy).”

In this real space conversion processing, an operation for converting the CCD coordinate system into the real space coordinate system, as describe above, and an additional operation may be performed for converting the 3-D coordinates (X, Y, Z) of an arbitrary point in a-three-dimensional space coordinate system into the 2-D coordinates (lcdcx, lcdcy) in a 2-D LCD coordinate system fixed with respect to a surface of the projection LCD 19 within the projecting section 13.

The relative geometry between the 2-D coordinates (lcdcx, lcdcy) and the 3-D coordinates (X, Y, Z) is described by the following four equations:
Y=−(Yptarget/PPZ)Z+Yptarget (9)
X=−(Xptarget/PPZ)Z+Xptarget (10)
Yptarget Ypftop−(lcdcy/Hp)×(Xpftop−Xpfbottom) (11)
Xptarget=Xpfstart+(lcdcx/Wp)×(Xpfend−Xpfstart) (12)

Representations of Additional Symbols

Xptarget and Yptarget

In this real space coordinate system X-Y-Z, as shown in FIG. 22, symbols “Xptarget” And “Yptarget” denote X coordinates and Y coordinates of a point of Intersection between a straight line obtained by extending forward an optical path along which light from the projecting section 13 enters the point of target on the document P. and the X-Y plane of this real space coordinate system X-Y-Z, respectively.

(0, 0, PPZ)

Further, in this real space coordinate system X-Y-Z, the coordinates of the position of an output pupil of the projecting section 13 are defined as “(0, 0, PPZ).”

Xpfstart, Xpfend, Ypftop and Ypfbottom

Still further, in this real space coordinate system X-Y-Z, a field of view of the projecting section 13 as viewed in the Y-axis direction is defined as a region extending from a point denoted by “Ypftop” to a point denoted by “Ypfbottom,” while a field of view of the projecting section 13 as viewed in the X-axis direction is defined as a region extending from a point denoted by “Xpfstart” to a point denoted by “Xpfend.”

Hp and Wp

Yet further, in this real space coordinate system X-Y-Z, symbol “Hp” denotes a length (or height) of the LCD 19 as viewed in the Y-axis direction, while symbol “Wp” denotes a length (or width) of the LCD 19 as viewed in the X-axis direction.

Upon entry of the 3-D coordinates (X, Y, Z) into equations (9)-(12) for the relationship defined by these equations (9)-(12) to be exploited, the 2-D coordinates (lcdcx, lodcy) in the LCD coordinate system are derived In an example, this allows a projection light-pattern to be calculated for enabling the projection LCD 19 to project an image (e.g., in text or graphics format) onto a projection plane having an arbitrary 3-D shape.

Flattening Image Processing

Although there has been described above the stereoscopic image processing to be executed at step 3609 depicted in FIG. 6, there will be described below the flattening image processing to be executed at step S611 depicted in the figure.

This flattening image processing allows, for example, a captured image of the document P actually curved or warped as shown in FIG. 1, to be flattened, thereby generation of a corrected captured-image of the document P as if it were captured with the document P not being curved.

This flattening image processing further allows a captured image of the document P rectangle-shaped in plan view (i.e., direct facing planar view) which was obtained by obliquely photographing the document P, to be flattened, thereby generation of a corrected captured-image of the document P as if it were captured in plan view. This flattening image processing is not essential in understanding the present invention, and is disclosed in more detail in the above-identified Japanese Patent Application Publication No. JP2005-293075. The further detailed description of this flattening image processing, therefore, will be omitted herein, while the publication is incorporated herein by reference.

As will be evident from the above description, in the present embodiment, the variable-size window VW constitutes an example of the “spatial-filter” set forth in the above mode (1), steps S101-S103 shown in FIG. 13 together constitute an example of the “spatial-filter configuration step” set forth in the same mode, step S104 shown in FIG. 13 constitutes an example of the “threshold setting step” set forth in the same mode, and information of luminance values constitutes an example of the “image information” set forth in the same mode.

Further, in the present embodiment, the fixed-size window described in reference to FIG. 20 constitutes an example of the “window function” set forth in the above mode (2), and the array-direction-size of the variable-size window VW constitutes an example of the “variable width” set forth in the above mode (4).

Still further, in the present embodiment, step S102 shown in FIG. 13 constitutes an example of the “spatial-frequency-characteristic calculation step” set forth in the above mode (10), and the representative light-pattern image constitutes an example of the “selected one of the plurality of different light-pattern images” set forth in the above modes (13) and (14).

Additionally, in the present embodiment, steps 5105-S108 shown in FIG. 13 together constitute an example of the “binarization step” set forth in the above mode (15), steps S103 and S104 together constitute an example of the “threshold-image generation step” set forth in the above mode (16), step S107 constitutes an example of the “binarized-image generation step” set forth in the same mode, step S109 shown in FIG. 13 constitutes an example of the “space-coded-image calculation step” set forth in the above mode (17), and step S1225 shown in FIG. 12(c) constitutes an example of the “three-dimensional-location calculation step” set forth in the above mode (18).

Still additionally, in the present embodiment, the coded-image generation program 36d constitutes an example of the “program” according to the above mode (19), and a portion of the ROM 36 which is assigned to store the coded-image generation program 36d constitutes an example of the “computer-readable medium” according to the above mode (20).

Still yet additionally, in the present embodiment, the image input/output device 1 constitutes an example of the “three-dimensional information obtaining apparatus” according to the above mode (21), a portion of the computer of the processing section 15 which is assigned to implement steps S101-S103 shown in FIG. 13 constitutes an example of the “spatial-filter configuration circuit” set forth in the same mode, a portion the computer which is assigned to implement step S104 shown in FIG. 13 constitutes an example of the “threshold setting circuit” set forth in the same mode, and information of luminance values constitutes an example of the “image information” set forth in the same mode.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method of obtaining three-dimensional information pertaining to an object of interest, based on a light-pattern image acquired by digitally photographing the object with patterned light being projected onto the object, the method comprising:
a spatial-filter configuration step of configuring a local adaptive spatial-filter for the light-pattern image, based on a spatial frequency characteristic of the light-pattern image having a plurality of sub-areas, on a sub-area-by-sub-area basis; and
a threshold setting step of setting local thresholds for the light-pattern image, based on image information acquired by locally applying the spatial filter to the light-pattern image, on a sub-area-by-sub-area basis, wherein the local thresholds are applicable to the respective sub-areas of the light-pattern image for obtaining the three-dimensional information pertaining to the object.

2. The method according to claim 1, wherein the spatial-filter configuration step includes:
acquiring the spatial frequency characteristic based on image information of each sub-area of the light-pattern image which is extracted from the light-pattern image by local application of a window function thereto, on a sub-area-by-sub-area basis; and
configuring the spatial filter based on the acquired spatial frequency characteristic, on a sub-area-by-sub-area basis.

3. The method according to claim 1, wherein the spatial filter is expressed by a matrix consisting of variable filter coefficients.

4. The method according to claim 1, wherein the spatial filter has a characteristic realized by at least one of a rectangular window having a variable width, and a low-pass filter having a variable cut-off frequency.

5. The method according to claim 1, wherein the patterned light is configured to have alternating bright portions and dark portions,
the light-pattern image is configured to have alternating bright portions and dark portions so as to be consistent with a pattern of alternating bright and dark portions of the patterned light, and
the spatial frequency characteristic indicates an alternation spatial-frequency at which the bright portions and the dark portions alternate within each sub-area of the light-pattern image.

6. The method according to claim 5, wherein the spatial-filter configuration step includes, when the spatial frequency characteristic indicates a frequency-intensity profile having local maxima of intensity at different spatial-frequencies within each sub-area of the light-pattern image, configuring the spatial filter based on at least one of the different spatial-frequencies, on a sub-area-by-sub-area basis.

7. The method according to claim 6, wherein the spatial-filter configuration step includes specifying the spatial frequency characteristic by application of Fourier transform to luminance distribution of the light-pattern image.

8. The method according to claim 6, wherein the spatial filter is in the form of a rectangular window having a variable width, and the spatial-filter configuration step includes a window-width determination step of determining the width of the rectangular window based on a selected one of the different spatial-frequencies which corresponds to the highest intensity among the local maxima of intensity within each frequency-intensity profile.

9. The method according to claim 6, wherein the spatial filter is in the form of a low-pass filter having a variable cut-off frequency, and
the spatial-filter configuration step includes a cut-off-frequency determination step of determining the cut-off frequency to be equal to a spatial frequency lower than a selected one of the different spatial-frequencies which corresponds to the highest intensity among the local maxima of intensity within each frequency-intensity profile, based on the selected spatial frequency.

10. The method according to claim 1, wherein the light-pattern image is formed by a plurality of pixels, and
the spatial-filter configuration step includes a spatial-frequency-characteristic calculation step of calculating the spatial frequency characteristic in association with a successively selected one of the plurality of pixels, based on luminance information indicative of a sub-plurality of the plurality of pixels which include the successively selected pixel and its at least one neighboring pixel.

11. The method according to claim 1, wherein the light-pattern image is formed by a plurality of pixels,
the plurality of pixels include a sub-plurality of non-adjacent pixels which are elected from the plurality of pixels so as not to be adjacent to each other, and
the spatial-filter configuration step includes a spatial-frequency-characteristic calculation step of calculating the spatial frequency characteristic in association with a successively selected one of the sub-plurality of elected non-adjacent pixels, based on luminance information indicative of a sub-plurality of the plurality of pixels which include the successively selected isolated-pixel and its at least one neighboring pixel.

12. The method according to claim 11, wherein the plurality of pixels further include a sub-plurality of non-elected pixels, in addition to the sub-plurality of elected non-adjacent pixels, and
the spatial-filter configuration step further includes a spatial-frequency-characteristic estimation step of estimating the spatial frequency characteristic data in association with a successively selected one of the sub-plurality of non-elected pixels, using the spatial frequency characteristic which is calculated as a result of implementation of the spatial-frequency-characteristic calculation step for at least one of the sub-plurality of elected non-adjacent pixels which is located around the successively selected non-elected pixel.

13. The method according to claim 1, wherein the patterned light is configured to have alternating bright portions and dark portions,
the light-pattern image is configured to have alternating bright portions and dark portions so as to be consistent with a pattern of alternating bright and dark portions of the patterned light,
the patterned light includes a plurality of light patterns different from each other in terms of an alternation spatial-frequency at which the bright portions and the dark portions alternate,
the light-pattern image includes light-pattern images different from each other which correspond to the plurality of different light-patterns, respectively,
the spatial-filter configuration step includes configuring the spatial filter using a selected one of the plurality of different light-pattern images, on a sub-area-by-sub-area basis, and
the threshold setting step includes allocating a series of the local thresholds to the plurality of different light-pattern images in common, on a sub-area-by-sub-area basis.

14. The method according to claim 13, wherein the selected one of different light-pattern images corresponds to a selected one of the plurality of different light-patterns in which the bright portions and the dark portions alternate in a substantially shortest alternation period among those of the plurality of different light-patterns.

15. The method according to claim 1, further comprising a binarization step of binarizing the light-pattern image using the local thresholds on a sub-area-by-sub-area basis, to thereby convert the light-pattern image into a binarized image.

16. The method according to claim 15, wherein the threshold setting step includes a threshold-image generation step of generating a threshold image by pixel-by-pixel arranging the thresholds in positional association with a plurality of pixels forming the light-pattern image, respectively, and
the binarization step includes a binarized-image generation step of generating the binarized image by making a pixel-by-pixel comparison between the generated threshold image and the light-pattern image with each other with respect to luminance value.

17. The method according to claim 15, further comprising a space-coded-image calculation step of calculating a space-coded image from the binarized image, based on the binarized image, according to a predetermined space-encoding algorithm.

18. The method according to claim 17, further comprising a three-dimensional-location calculation step of calculating as the three-dimensional information pertaining to the object, three-dimensional locations of a plurality of pixels forming the object, based on the calculated space-coded image.

19. A computer-readable medium having stored therein a program which, when executed by a computer, obtains three-dimensional information pertaining to an object of interest, based on a light-pattern image acquired by digitally photographing the object with spatially patterned light being projected onto the object,
the program comprising:
instructions for configuring a local adaptive spatial-filter for the light-pattern image, based on a spatial frequency characteristic of the light-pattern image having a plurality of sub-areas, on a sub-area-by-sub-area basis; and
instructions for setting local thresholds for the light-pattern image, based on image information acquired by locally applying the spatial falter to the light-pattern image, on a sub-area-by-sub-area basis, wherein the local thresholds are applicable to the respective sub-areas of the light-pattern image for obtaining the three-dimensional information pertaining to the object.

20. An apparatus of obtaining three-dimensional information pertaining to an object of interest, based on a light-pattern image acquired by digitally photographing the object with spatially patterned light being projected onto the object, the apparatus comprising;
a spatial-filter configuration circuit adapted to configure a local adaptive spatial-filter for the light-pattern image, based on a spatial frequency characteristic of the light-pattern image having a plurality of sub-areas, on a sub-area-by-sub-area basis; and
a threshold setting circuit adapted to set local thresholds for the light-pattern Image, based on image information acquired by locally applying the spatial filter to the light-pattern image, on a sub-area-by-sub-area basis, wherein the local thresholds are applicable to the respective sub-areas of the light-pattern image for obtaining the three-dimensional information pertaining to the object.
